(19) United States
(12) Patent Application Publication
(10) Pub. No.: US 2017/0336013 A1
(43) Pub. Date: Nov. 23, 2017

(54) CHEMICAL CONVERSION-TREATED STEEL PIPE

(71) Applicant: NISSHIN STEEL CO., LTD., Tokyo (JP)

(72) Inventors: Masanori MATSUNO, Osaka (JP); Masaya YAMAMOTO, Osaka (JP)

(21) Appl. No.: 15/520,352

(22) PCT Filed: Oct. 20, 2015
(86) PCT No.: PCT/JP2015/005290

§ 371 Date: Apr. 19, 2017

(30) Foreign Application Priority Data
Oct. 22, 2014 (JP) 2014-215170

(51) Int. Cl. F16L 58/10; C23C 18/48; C23C 4/16; F16L 9/17; C23C 2/38

(52) U.S. Cl. CPC F16L 58/1072; F16L 9/17; C23C 2/38; C23C 4/16; C23C 18/48

(57) ABSTRACT

A chemical conversion-treated steel pipe has a chemical conversion treatment film on a plated layer on a steel sheet. The plated layer is configured from a zinc alloy comprising 0.05-60 mass % aluminum and 0.1-10.0 mass % magnesium. The chemical conversion treatment film contains a fluorine resin, a base resin, metal flakes and a chemical conversion treatment component. The base resin is one or more selected from a group consisting of polyurethane, polyester, acrylic resins, epoxy resins and polyolefin. The content of fluorine resin with respect to the total amount of fluorine resin and base resin is at least 3.0 mass % calculated as fluorine atoms. The content of the base resin with respect to 100 parts by mass of the fluorine resin is at least 10 parts by mass. The content of metal flakes in the chemical conversion treatment film is greater than 20 mass % up to and including 60 mass %.

### TECHNICAL FIELD

The present invention relates to a chemical conversion-treated steel pipe.

### BACKGROUND ART

Plated steel sheets are suitably used for exterior building materials. Plated steel sheets to be used for exterior building materials are required to have weatherability. As the plated steel sheet, known are chemical conversion-treated steel sheets including a plated steel sheet including a zinc-based plating layer containing aluminum and a chemical conversion treatment coating film which is disposed on the plated steel sheet and contains a fluororesin, a non-fluororesin, and a 4A metal compound (e.g., see PTL 1). The chemical conversion-treated steel sheet has the adhesion of the chemical conversion treatment coating film and weatherability to a degree sufficient for exterior building materials.

### CITATION LIST

### Patent Literature

PTL 1

WO2011/158513

### SUMMARY OF INVENTION

### Technical Problem

The chemical conversion-treated steel sheet has weatherability sufficient for exterior building materials. However, the chemical conversion-treated steel sheet has a high gloss. Thus, the gloss is required to be reduced in consideration for the surrounding environment of a building. In addition, the chemical conversion-treated steel sheet may discolor over time after exposure due to the oxidation of the plating surface.

Although the chemical conversion-treated steel sheet can be used as a material for steel pipes, steel pipes produced with the chemical conversion-treated steel sheet may have insufficient properties such as weatherability. This is because, in the steel pipe, which is typically produced by welding a plated steel sheet shaped into a hollow cylinder and bead-cutting the welded portion generated, the functional layer such as a plating layer and a chemical conversion treatment coating film is deteriorated in the bead-cutting and the steel sheet itself is exposed. Accordingly, a steel pipe having the expected function possessed by the plated steel sheet, such as weatherability, has been desired.

An object of the present invention is to provide a chemical conversion-treated steel pipe which has sufficient adhesion of the chemical conversion treatment coating film and weatherability and exhibits suppressed gloss and suppressed discoloration over time.

### Solution to Problem

The present inventors have found that use of a fluororesin excellent in weatherability and a non-fluororesin and a metal flake in combination as a material for a chemical conversion treatment coating film on a plated steel sheet provides a chemical conversion-treated steel sheet which is excellent in the adhesion of a chemical conversion treatment coating film and has a moderate gloss and does not undergo the above-mentioned discoloration over time, and further studied to complete the present invention.

Specifically, the present invention provides the following chemical conversion-treated steel pipes.

[1] A chemical conversion-treated steel pipe including: a plated steel pipe produced by welding a plated steel sheet; and a chemical conversion treatment coating film disposed on the surface of the plated steel pipe, in which: the plated steel sheet includes a steel sheet and a zinc alloy disposed on the surface of the steel sheet and containing 0.05 to 60 mass % of aluminum and 0.1 to 10.0 mass % of magnesium, the chemical conversion treatment coating film contains a fluororesin, a base resin, a metal flake, and a chemical conversion treatment component, the base resin is one or more selected from the group consisting of a polyurethane, a polyester, an acrylic resin, an epoxy resin, and a polyolefin, the content of the fluororesin relative to the total amount of the fluororesin and the base resin is 3.0 mass % or more in terms of fluorine atoms, the content of the base resin relative to 100 parts by mass of the fluororesin in the chemical conversion treatment coating film is 10 parts by mass or more, and the content of the metal flake in the chemical conversion treatment coating film is more than 20 mass % and 60 mass % or less.
[2] The chemical conversion-treated steel pipe according to [1], in which the metal flake is one or more selected from the group consisting of an aluminum flake, an aluminum alloy flake, and a stainless steel flake.
[3] The chemical conversion-treated steel pipe according to [1] or [2], in which the chemical conversion treatment coating film has a film thickness of 0.5 to 10 μm.
[4] The chemical conversion-treated steel pipe according to any one of [1] to [3], in which the content of the base resin relative to 100 parts by mass of the fluororesin in the chemical conversion treatment coating film is 900 parts by mass or less.
[5] The chemical conversion-treated steel pipe according to any one of [1] to [4], in which: the chemical conversion treatment component includes a valve metal compound including one or more selected from the group consisting of Ti, Zr, Hf, V, Nb, Ta, Mo, and W, and the content of the valve metal compound in the chemical conversion treatment coating film based on the chemical conversion treatment coating film is 0.005 to 5.0 mass % in terms of metal.
[6] The chemical conversion-treated steel pipe according to any one of [1] to [5], in which the chemical conversion treatment coating film further contains one or both of a silane coupling agent and a phosphate.
[7] The chemical conversion-treated steel pipe according to any one of [1] to [6], in which: the plated steel sheet has been pretreated with a phosphate compound or a valve metal component, and the valve metal component is one or more selected from the group consisting of Ti, Zr, Hf, V, Nb, Ta, Mo, and W.
[8] The chemical conversion-treated steel pipe according to any one of [1] to [7], in which: the plated steel pipe further includes a thermal spray-repaired layer covering a welded portion of the plated steel pipe, and the Al concentration in the surface of the thermal spray-repaired layer is 0.05 atom % or more.
[9] The chemical conversion-treated steel pipe according to any one of [1] to [8], in which the chemical conversion treatment coating film further contains a pigment.
[10] The chemical conversion-treated steel pipe according to any one of [1] to [9], in which the chemical conversion treatment coating film further contains a wax.
[11] The chemical conversion-treated steel pipe according to any one of [1] to [10], being a steel pipe for a building frame of an agricultural greenhouse.

### Advantageous Effects of Invention

The present invention can provide a chemical conversion-treated steel pipe which has sufficient weatherability and adhesion of a chemical conversion treatment coating film and exhibits suppressed gloss and suppressed discoloration over time. In addition, the chemical conversion-treated steel pipe undergoes a sufficiently suppressed change of the appearance, and thus can be suitably used even for exterior building materials.

### BRIEF DESCRIPTION OF DRAWINGS

FIG. 1A schematically illustrates the layered structure of a chemical conversion-treated steel pipe according to one embodiment of the present invention, and

FIG. 1B schematically illustrates the layered structure in closeup.

### DESCRIPTION OF EMBODIMENTS

Now, one embodiment of the present invention will be described.

1. Chemical Conversion-Treated Steel Pipe

A chemical conversion-treated steel pipe according to the present embodiment includes a chemical conversion treatment coating film disposed on/above the surface of a plated steel pipe. In the following, constituents of the chemical conversion-treated steel pipe according to the present embodiment will be described.

[Plated Steel Pipe]

The plated steel pipe is produced by welding a plated steel sheet. For example, a plated steel sheet is shaped into a pipe so that peripheries of the plated steel sheet to be jointed together contact each other to produce what is called an open pipe, and the peripheries are welded, and thus the plated steel pipe is produced. The open pipe is produced by using a known method such as roll forming and roll-less forming. Examples of the welding include high-frequency welding. The cross-sectional shape of the plated steel pipe, which is typically circular, may be, for example, elliptical, polygonal, or wheel-shaped. In addition, the plated steel pipe may be a straight pipe or a bent pipe.

In the plated steel pipe, the portion after being welded (welded portion) typically forms a ridge. From the viewpoint of shaping of the plated steel pipe, the plated steel pipe may further include a bead-cut portion provided to the welded portion. Bead-cutting can be achieved by using a known method to cut the protruding welded portion.

From the viewpoint of enhancement of the corrosion resistance of the welded portion, the plated steel pipe may further include a thermal spray-repaired layer covering the welded portion. The thermal spray-repaired layer is only required to cover the welded portion, and for example, may be disposed on the whole of the peripheral surface of the plated steel pipe. However, the thermal spray-repaired layer is typically disposed on the welded portion and the vicinity thereof. For example, the thermal spray-repaired layer is disposed on a portion with a width of 10 to 50 mm centered at the welded portion in the peripheral direction of the plated steel pipe.

The thermal spray-repaired layer can be produced by using a known thermal spray method such as single thermal spray, double thermal spray, and triple thermal spray. Examples of metal materials used for thermal spray (thermal spray core line) include Al, Mg, Zn, and allows of them. In the case that the metal material is Al and Mg (Al—Mg), for example, the content of Mg in the thermal spray-repaired layer is preferably 5 to 20 mass % from the viewpoint of ensuring the processability of the plated steel pipe. In the case that the metal material is Al and Zn (Al—Zn), the content of Zn is preferably 0.05 to 30 mass % from the viewpoint of allowing a pinhole portion to exert a sacrificial anticorrosive effect and ensuring the processability of a welded plated steel pipe. In addition, the Al concentration in the surface of the thermal spray-repaired layer is preferably 0.05 atom % or more from the viewpoint of enhancement of the adhesion of the thermal spray-repaired layer to the chemical conversion treatment coating film.

The content of metal elements in the thermal spray-repaired layer can be adjusted in accordance with the type of the thermal spray core line and the number of layers of thermal spray. The content of metal elements in the thermal spray-repaired layer or the Al concentration in the surface of the thermal spray-repaired layer can be measured in element analysis with an apparatus for electron spectroscopy for chemical analysis (ESCA).

Especially, a thermal spray-repaired layer produced through Al—Zn—Al triple thermal spray is more preferred. The Al as the first layer enhances the adhesion of the thermal spray-repaired layer to the welded portion, the Zn as the second layer exerts an effect of suppressing the corrosion of the substrate steel via an sacrificial anticorrosive action to iron, and the Al as the third layer even prevents white rust generation and further enhances the barrier function of the thermal spray-repaired layer.

The average amount of thermal spray-repaired layer deposition is preferably 10 to 30 μm. The average amount of deposition refers to an average value of the thickness of the thermal spray-repaired layer in the welded portion. When the average amount of deposition is too small, the corrosion resistance of the welded portion may not recover sufficiently; and when the average amount of deposition is too large, the production cost increases and the adhesion of the thermal spray-repaired layer to the substrate steel of the plated steel sheet may be insufficient.

[Plated Steel Sheet]

The plated steel sheet includes a steel sheet and a plating layer. The plating layer contains a zinc alloy containing 0.05 to 60 mass % of aluminum and 0.1 to 10.0 mass % of magnesium from the viewpoint of corrosion resistance and designability. The thickness of the plated steel sheet may be determined in accordance with an application of the chemical conversion-treated steel pipe, and for example, is 0.2 to 6 mm. The plated steel sheet may be a flat sheet or a corrugated sheet, and the shape in plane of the plated steel sheet may be a rectangle or a shape other than rectangles.

Examples of the plated steel sheet include hot-dip aluminum-magnesium-zinc-plated steel sheets (hot-dip Al—Mg—Zn-plated steel sheets) containing a zinc alloy containing aluminum and magnesium, and hot-dip aluminum-magnesium-silicon-zinc-plated steel sheets (hot-dip Al—Mg—Si—Zn-plated steel sheets) containing a zinc alloy containing aluminum, magnesium and silicon.

Examples of the steel sheet which serves as a substrate of the plated steel sheet (substrate steel sheet) include sheets of low-carbon steel, medium-carbon steel, high-carbon steel, and alloy steel. A configuration in which the substrate steel sheet is a steel sheet for deep drawing of low-carbon Ti-added steel, low-carbon Nb-added steel, etc. is preferred from the viewpoint of enhancement of the processability of the chemical conversion-treated steel pipe.

[Chemical Conversion Treatment Coating Film]

The chemical conversion treatment coating film is a layer of a component deposited in surface-treating the plated steel pipe, and is a layer containing a reaction product (chemical conversion treatment component) of a reaction between the surface of the plating layer and a pre-chemical conversion treatment component in a chemical conversion treatment solution described later. The chemical conversion treatment coating film contains a fluororesin, a base resin, a metal flake, and a chemical conversion treatment component.

The fluororesin enhances the weatherability (ultraviolet resistance) of the chemical conversion treatment coating film. One fluororesin or one or more fluororesins may be used. The content of the fluororesin relative to the total amount of the fluororesin and the base resin is 3.0 mass % or more in terms of fluorine atoms. When the content of the fluororesin in terms of fluorine atoms is less than 3.0 mass %, the chemical conversion-treated steel pipe may have an insufficient weatherability. The fluorine atom content in the chemical conversion treatment coating film can be measured, for example, by using an X-ray fluorescence spectrometer.

Examples of the fluorine-containing resin include fluorine-containing olefin resins. A fluorine-containing olefin resin is a polymer compound formed by replacing a part or all of the hydrogen atoms in a hydrocarbon group constituting an olefin with a fluorine atom. The fluorine-containing olefin resin is preferably an aqueous fluorine-containing resin further having a hydrophilic functional group from the viewpoint of facilitating handling of the fluororesin in producing the chemical conversion treatment coating film.

Examples of the hydrophilic functional group in the aqueous fluorine-containing resin include a carboxyl group, a sulfonic acid group, and salts thereof. Examples of the salt include ammonium salts, amine salts, and alkali metal salts. The content of the hydrophilic functional group in the aqueous fluorine-containing resin is preferably 0.05 to 5 mass % from the viewpoint of enabling formation of an emulsion of the fluororesin without using an emulsifier. In the case that both a carboxyl group and a sulfonic acid group are present as the hydrophilic functional group, the mole ratio of the carboxyl group to the sulfonic acid group is preferably 5 to 60. The content of the hydrophilic functional group and the number average molecular weight of the aqueous fluorine-containing resin can be measured by using gel permeation chromatography (GPC).

The number average molecular weight of the aqueous fluorine-containing resin is preferably 1,000 or higher, more preferably 10,000 or higher, and particularly preferably 200,000 or higher from the viewpoint of enhancement of the water resistance of the chemical conversion treatment coating film. The number average molecular weight is preferably 2,000,000 or lower from the viewpoint of preventing the chemical conversion treatment coating film from gelling in producing it.

Examples of the aqueous fluorine-containing resin include copolymers of a fluoroolefin and a monomer containing a hydrophilic functional group. Examples of the monomer containing a hydrophilic functional group include carboxyl group-containing monomers and sulfonic acid group-containing monomers.

Examples of the fluoroolefin include tetrafluoroethylene, trifluoroethylene, chlorotrifluoroethylene, hexafluoropropylene, vinyl fluoride, vinylidene fluoride, pentafluoropropylene, 2,2,3,3-tetrafluoropropylene, 3,3,3-trifluoropropylene, bromotrifluoroethylene, 1-chloro-1,2-difluoroethylene, and 1,1-dichloro-2,2-difluoroethylene. Among them, perfluoroolefins such as tetrafluoroethylene and hexafluoropropylene and vinylidene fluoride are preferred from the viewpoint of enhancement of the weatherability of the chemical conversion-treated steel pipe.

Examples of the carboxyl group-containing monomer include unsaturated carboxylic acids and carboxyl group-containing vinyl ether monomers, and esters thereof, and acid anhydrides thereof.

Examples of the unsaturated carboxylic acid include acrylic acid, methacrylic acid, vinylacetic acid, crotonic acid, cinnamic acid, itaconic acid, itaconic acid monoesters, maleic acid, maleic acid monoesters, fumaric acid, fumaric acid monoesters, 5-hexenoic acid, 5-heptenoic acid, 6-heptenoic acid, 7-octenoic acid, 8-nonenoic acid, 9-decenoic acid, 10-undecenoic acid, 11-dodecenoic acid, 17-octadecenoic acid, and oleic acid.

Examples of the carboxyl group-containing vinyl ether monomer include 3-(2-allyloxyethoxycarbonyl)propionic acid, 3-(2-allyloxybutoxycarbonyl)propionic acid, 3-(2-vinyloxyethoxycarbonyl)propionic acid, and 3-(2-vinyloxybutoxycarbonyl)propionic acid.

Examples of the sulfonic acid group-containing monomer include vinylsulfonic acid, allylsulfonic acid, methallylsulfonic acid, styrenesulfonic acid, 2-acrylamide-2-methylpropanesulfonic acid, 2-methacryloyloxyethanesulfonic acid, 3-methacryloyloxypropanesulfonic acid, 4-methacryloyloxybutanesulfonic acid, 3-methacryloyloxy-2-hydroxypropanesulfonic acid, 3-acryloyloxypropanesulfonic acid, allyloxybenzenesulfonic acid, methallyloxybenzenesulfonic acid, isoprenesulfonic acid, and 3-allyloxy-2-hydroxypropanesulfonic acid.

The copolymer may further contain an additional copolymerizable monomer as the monomer. Examples of the additional monomer include carboxylic acid vinyl esters, alkyl vinyl ethers, and fluorine-free olefins.

The carboxylic acid vinyl ester is used for the purpose of enhancing the compatibility of the components of the chemical conversion treatment coating film or increasing the glass transition temperature of the fluororesin. Examples of the carboxylic acid vinyl ester include vinyl acetate, vinyl propionate, vinyl butyrate, vinyl isobutyrate, vinyl pivalate, vinyl caproate, vinyl versatate, vinyl laurate, vinyl stearate, vinyl cyclohexylcarboxylate, vinyl benzoate, and vinyl p-t-butylbenzoate.

The alkyl vinyl ether is used for the purpose of, for example, enhancing the plasticity of the chemical conversion treatment coating film. Examples of the alkyl vinyl ether include methyl vinyl ether, ethyl vinyl ether, and butyl vinyl ether.

The fluorine-free olefin is used for the purpose of, for example, enhancing the flexibility of the chemical conversion treatment coating film. Examples of the fluorine-free olefin include ethylene, propylene, n-butene, and isobutene.

For the fluororesin, a copolymer of the above monomers can be used, and alternatively a commercial product may be used. Examples of the commercial product include SIFCLEAR F Series manufactured by JSR Corporation (“SIFCLEAR” is a registered trademark owned by the manufacturer) and Obbligato manufactured by AGC COAT-TECH Co., Ltd. (“Obbligato” is a registered trademark owned by the manufacturer).

The base resin is one or more selected from the group consisting of a polyurethane, a polyester, an acrylic resin, an epoxy resin, and a polyolefin. The base resin contains no fluorine atoms.

The content of the base resin in the chemical conversion treatment coating film is 10 parts by mass or more relative to 100 parts by mass of the fluororesin. When the content is less than 10 parts by mass, the adhesion of the chemical conversion treatment coating film to the plated steel pipe and the corrosion resistance of the chemical conversion-treated steel pipe may be insufficient. The content is preferably 900 parts by mass or less and more preferably 400 parts by mass or less from the viewpoint of suppression of the change of appearance over time due to the degradation of the weatherability of the chemical conversion treatment coating film and reduction of retention of the metal flake due to the degradation over time, etc.

The base resin contributes to the adhesion of the chemical conversion treatment coating film to the plated steel pipe and the retention of the metal flake. From such a viewpoint, the content of the base resin in the chemical conversion treatment coating film can be appropriately determined in the range of 10 to 900 parts by mass relative to 100 parts by mass of the fluororesin.

The polyurethane is preferably a water-soluble or water-dispersible polyurethane and more preferably a self-emulsifying polyurethane from the viewpoint of easiness and safety in producing the chemical conversion treatment coating film. These have the structure of a reaction product of a reaction between an organic polyisocyanate compound and a polyol compound.

Examples of the organic polyisocyanate compound include aliphatic diisocyanates and alicyclic diisocyanates. Examples of the aliphatic diisocyanate include phenylene diisocyanate, tolylene diisocyanate, diphenylmethane diisocyanate, and naphthalene diisocyanate. Examples of the alicyclic diisocyanate include cyclohexane diisocyanate, isophorone diisocyanate, norbornane diisocyanate, xylylene diisocyanate, and tetramethylxylylene diisocyanate.

Examples of the polyol compound include polyolefin polyols. Examples of the polyolefin polyol include polyester polyols, polyether polyols, polycarbonate polyols, polyacetal polyols, polyacrylate polyols, and polybutadiene.

For the polyurethane, a synthesized product from the above compounds can be used, and alternatively a commercial products may be used. Examples of the commercial product include “SUPERFLEX” manufactured by DKS Co., Ltd. (a registered trademark owned by the manufacturer) and “HYDRAN” manufactured by DIC Corporation (a registered trademark owned by the manufacturer).

For the polyester, a synthesized product can be used, and alternatively a commercial products may be used. Examples of the commercial product include “VYLONAL” (a registered trademark owned by Toyobo CO., LTD.) manufactured by TOYOBO STC CO., LTD.

For the acrylic resin, a synthesized product can be used, and alternatively a commercial products may be used. Examples of the commercial product include “PATELACOL” manufactured by DIC Corporation (a registered trademark owned by the manufacturer), “Ultrasol” manufactured by Aica Kogyo Co., Ltd., (a registered trademark owned by the manufacturer) and “BONRON” manufactured by Mitsui Chemicals, Inc. (a registered trademark owned by the manufacturer).

For the epoxy resin, a synthesized product can be used, and alternatively a commercial products may be used. Examples of the commercial product include “MODEPICS” manufactured by Arakawa Chemical Industries, Ltd. (a registered trademark owned by the manufacturer) and “ADEKA RESIN” manufactured by ADEKA CORPORATION (a registered trademark owned by the manufacturer).

For the polyolefin, a synthesized product can be used, and alternatively a commercial products may be used. Examples of the commercial product include “ARROWBASE” manufactured by UNITIKA LTD (a registered trademark owned by the manufacturer).

The metal flake suppresses the gloss of the chemical conversion-treated steel pipe and contributes to the development of perspiration/fingerprint resistance and blackening resistance in the chemical conversion-treated steel pipe. From such a viewpoint, the content of the metal flake in the chemical conversion treatment coating film is more than 20 mass % and 60 mass % or less. When the content of the metal flake is 20 mass % or less, the chemical conversion-treated steel pipe may have too high a gloss and an insufficient perspiration/fingerprint resistance and blackening resistance. When the content of the metal flake is more than 60 mass %, the adhesion of the chemical conversion treatment coating film to the plated steel pipe and the corrosion resistance of the chemical conversion-treated steel pipe may be insufficient. Here, the “perspiration/fingerprint resistance” refers to a property to prevent discoloration at a portion of a chemical conversion-treated steel pipe to which perspiration from a worker handling the chemical conversion-treated steel pipe is attached through operation such as conveyance and attachment (e.g., at a portion having a fingerprint-like mark).

The size of the metal flake can be appropriately determined in a range which allows the above function to be exerted. For example, the thickness of the metal flake is 0.01 to 2 μm, and the particle diameter (maximum diameter) of the metal flake is 1 to 40 μm. The size of the metal flake can be measured with a scanning electron microscope (SEM). The size value may be the average value or representative value of measurements, or the catalog value.

Examples of the metal flake include flakes made of metal and glass flakes provided with a metal plating on the surface. Examples of the metal material for the metal flake include aluminum and alloys thereof, iron and alloys thereof, copper and alloys thereof, silver, nickel, and titanium. Examples of the aluminum alloy include Al—Zn, Al—Mg, and Al—Si alloys. Examples of the iron alloy include stainless steels. Examples of the copper alloy include bronze. The metal flake is preferably one or more selected from the group consisting of an aluminum flake, an aluminum alloy flake, and a stainless steel flake from the viewpoint of, for example, corrosion resistance and high designability. The content of Mg in the metal material for the metal flake may be determined in a range which causes the metal flake to undergo substantially no blackening.

The metal flake may be surface-treated in advance with a surface treatment agent. Use of the surface-treated metal flake enables further enhancement of the water resistance and dispersiveness of the metal flake in a chemical conversion treatment solution described later in a description of the producing method. Examples of a coating film formed on the surface of the metal flake with the surface treatment agent include a molybdate coating film, a phosphate coating film, a silica coating film, and a coating film formed of a silane coupling agent and an organic resin.

Examples of the silane coupling agent include methyltriethoxysilane, methyltrimethoxysilane, dimethyldimethoxysilane, trimethylmethoxysilane, dimethyldiethoxysilane, trimethylethoxysilane, 3-aminopropyltrimethoxysilane, N-methyl-3-aminopropyltrimethoxysilane, 3-aminopropyltriethoxysilane, 3-aminopropyltris(2-methoxyethoxy)silane, N-aminoethyl-3-aminopropyltrimethoxysilane, N-aminoethyl-3-aminopropylmethyldimethoxysilane, 3-methacryloxypropyltrimethoxysilane, 3-methacryloxypropylmethyldimethoxysilane, 3-acryloxypropyltrimethoxysilane, 3-glycidyloxypropyltrimethoxysilane, 3-glycidyloxypropylmethyldimethoxysilane, 3-mercaptopropyltrimethoxysilane, 3-mercaptopropyltriethoxysilane, 3-mercaptopropylmethyldimethoxysilane, vinyltrichlorosilane, vinyltrimethoxysilane, vinyltriethoxysilane, vinyltris(2-methoxyethoxy)silane, vinyltriacetoxysilane, 3-(3,4-epoxycyclohexylethyltrimethoxy)silane, γ-aminopropyltriethoxysilane, N-β-(aminoethyl)-γ-aminopropyltrimethoxysilane, 3-ureidopropyltriethoxysilane, 3-chloropropyltrimethoxysilane, 3-anilidopropyltrimethoxysilane, 3-(4,5-dihydroimidazolepropyltriethoxy)silane, N-phenyl-3-aminopropyltrimethoxysilane, heptadecafluorodecyltrimethoxysilane, tridecafluorooctyltrimethoxysilane, trifluoropropyltrimethoxysilane, 3-isocyanatopropyltriethoxysilane, and p-styryltrimethoxysilane.

For the metal flake, a collapsed product of a metal particle can be used, and alternatively a commercial products may be used. Examples of the commercial product include WXM-U75C, EMR-D6390, WL-1100, GD-20X, and PFA4000 manufactured by TOYO ALUMINIUM K.K.

When the film thickness of the chemical conversion treatment coating film is too small, the expected functions, including the weatherability of the chemical conversion-treated steel pipe, provided by the chemical conversion treatment coating film may be insufficient; and when the film thickness is too large, the productivity may be degraded. From such a viewpoint, the film thickness is preferably 0.5 to 10 μm and more preferably 1 to 4 μm. The film thickness can be measured with a known film thickness meter, and can be adjusted in accordance with the amount of the chemical conversion treatment solution applied, the number of times of applications, and the like.

The chemical conversion treatment component is a reaction product on the surface of the plating layer, and may be in a single-component configuration or in a multiple-component configuration. Examples of the chemical conversion treatment component include valve metal compounds such as 4A metal compounds and molybdate compounds. The valve metal compound is in a form of the above reaction product, such as a salt, an oxide, a fluoride, and a phosphate salt. Examples of the 4A metal compound include hydroacid salts, ammonium salts, alkali metal salts, and alkali earth metal salts of a metal containing a 4A metal. Examples of the molybdate compound include ammonium molybdate and alkali metal salts of molybdic acid.

The valve metal compound is a compound containing one or more selected from the group consisting of Ti, Zr, Hf, V, Nb, Ta, Mo, and W. Among them, V and Nb are preferred. The valve metal compound contributes to enhancement of the weatherability and corrosion resistance of the chemical conversion-treated steel pipe or suppression of an excessive gloss of the chemical conversion-treated steel pipe.

The content of the valve metal compound in the chemical conversion treatment coating film is preferably 0.005 to 5.0 mass % in terms of metal from the viewpoint of enhancement of the weatherability and corrosion resistance and gloss adjustment. When the content is less than 0.005 mass %, the above effect may be insufficient; and when the content is more than 5.0 mass %, the above effect may become saturated. The content of the valve metal compound in the chemical conversion treatment coating film can be measured with an X-ray fluorescence spectrometer or a high-frequency inductively coupled plasma (ICP) emission spectrometer.

The chemical conversion treatment coating film may further contain an additional component other than the fluororesin, the base resin, the metal flake, and the chemical conversion treatment component, within a range in which the effect of the present embodiment can be obtained. Examples of the additional component include a silane coupling agent, a phosphate compound, an etching compound, a pigment, and a wax. One of the additional components or one or more thereof may be contained.

The silane coupling agent contributes to enhancement of the adhesion of the chemical conversion treatment coating film. Examples of the silane coupling agent include silane compounds having a bondable functional group and condensates thereof. Examples of the bondable functional group include an amino group, an epoxy group, a mercapto group, an acryloxy group, a methacryloxy group, an alkoxy group, a vinyl group, a styryl group, an isocyanate group, and a chloropropyl group. One of the bondable functional group or one or more thereof may be present.

The content of the silane coupling agent in the chemical conversion treatment coating film is preferably 0.1 to 5.0 mass % from the viewpoint of the above-mentioned enhancement of the adhesion. When the content is less than 0.1 mass %, the effect to enhance the adhesion may be insufficient; and when the content is more than 5.0 mass %, the effect to enhance the adhesion may become saturated. The content of the silane coupling agent in the chemical conversion treatment coating film can be measured with an X-ray fluorescence spectrometer or an ICP emission spectrometer.

The phosphate compound contributes to enhancement of the corrosion resistance of the chemical conversion treatment coating film. The “phosphate compound” refers to a water-soluble compound having a phosphate anion. Examples of the phosphate compound include sodium phosphate, ammonium phosphate, magnesium phosphate, potassium phosphate, manganese phosphate, zinc phosphate, orthophosphates, metaphosphates, pyrophosphates (diphosphates), triphosphates, and tetraphosphates.

The content of the phosphate compound in the chemical conversion treatment coating film is preferably 0.05 to 3.0 mass % in terms of phosphorus atoms from the viewpoint of the above-mentioned enhancement of the corrosion resistance. When the content is less than 0.05 mass %, the effect to enhance the adhesion may be insufficient; and when the content is more than 3.0 mass %, the action to enhance the corrosion resistance becomes saturated, and in addition the stability of a chemical treatment solution may be lowered. The content of the phosphate compound in the chemical conversion treatment coating film can be measured with an X-ray fluorescence spectrometer or an ICP emission spectrometer.

The etching compound is a compound, for example, containing one or more selected from the group consisting of Mg, Ca, Sr, Mn, B, Si, and Sn. The etching compound contributes to enhancement of the water resistance of the chemical conversion treatment coating film through densification of the chemical conversion treatment coating film. Examples of the etching compound include salts of the above elements.

The content of the etching compound in the chemical conversion treatment coating film is preferably 0.005 to 2.0 mass % in terms of atoms of the above element from the viewpoint of the above-mentioned enhancement of the water resistance. When the content is less than 0.005 mass %, the above effect may be insufficient; and when the content is more than 2.0 mass %, the above effect may become saturated. The content of the etching compound in the chemical conversion treatment coating film can be measured with an X-ray fluorescence spectrometer or an ICP emission spectrometer.

The pigment contributes to suppression of the gloss and discoloration over time of the chemical conversion-treated steel pipe. One pigment or one or more pigments may be contained. The pigment may be an inorganic pigment or an organic pigment. Examples of the inorganic pigment include carbon black, silica, titania, and alumina. Examples of the organic pigment include resin particles such as an acrylic resin. Although “titania” contains titanium as a 4A metal, titania is herein classified into a pigment because of the excellent discoloration-suppressing effect.

The wax contributes to enhancement of the processability of the chemical conversion-treated steel pipe. From the viewpoint of developing the expected processability, the melting point of the wax is preferably 80 to 150° C. Examples of the wax include fluorine-containing waxes, polyethylene waxes, and styrene waxes.

The content of the wax in the chemical conversion treatment coating film is preferably 0.5 to 5 mass % from the viewpoint of the above-mentioned enhancement of the processability. When the content is less than 0.5 mass %, the effect to enhance the processability may be insufficient; and when the content is more than 5 mass %, collapse of piled coils in piling may occur. The content of the wax in the chemical conversion treatment coating film can be measured by using a known quantitative analysis method such as gas chromatography, high performance liquid chromatography, and mass spectrometry.

The chemical conversion treatment coating film can be produced by applying a chemical conversion treatment solution on the plated steel pipe followed by drying.

The chemical conversion treatment solution can be applied on the surface of the plated steel pipe by using a known application method such as a roll coating method, a curtain flow method, a spin coating method, a spraying method, a dipping method, and a dropping method. The thickness of a liquid film of the chemical conversion treatment solution can be adjusted by using felt drawing, an air wiper, or the like. The surface for application may be the outer peripheral surface or inner peripheral surface of the plated steel pipe. The chemical conversion treatment solution applied on the surface of the plated steel pipe may be dried at normal temperature, but is preferably dried at a temperature of 50° C. or higher from the viewpoint of productivity (continuous operation). The drying temperature is preferably 300° C. or lower from the viewpoint of preventing the components in the chemical conversion treatment solution from being thermally decomposed.

The chemical conversion treatment solution contains the fluororesin, the base resin, the metal flake, and a pre-chemical conversion treatment component, and may further contain the above-described additional component. The pre-chemical conversion treatment component is a precursor of the chemical conversion treatment component. The pre-chemical conversion treatment component may be the same as or different from the chemical conversion treatment component.

The content of the fluororesin relative to the total amount of the fluororesin and the base resin in the chemical conversion treatment solution is 3.0 mass % or more in terms of fluorine atoms; the content of the base resin relative to 100 parts by mass of the fluororesin in the chemical conversion treatment solution is 10 parts by mass or more; and the content of the metal flake relative to the solid content in the chemical conversion treatment solution is more than 20 mass % and 60 mass % or less. The content of the valve metal compound as the pre-chemical conversion treatment component relative to the solid content in the chemical conversion treatment solution is 0.005 to 5.0 mass % in terms of metal. The content of the additional pre-chemical conversion treatment component relative to the solid content in the chemical conversion treatment solution is 0.005 to 2.0 mass % in terms of atoms of inorganic element characteristic of the additional pre-chemical conversion treatment component. Here, the “solid content” in the chemical conversion treatment solution refers to components in the chemical conversion treatment solution which are contained in the chemical conversion treatment coating film.

The chemical conversion treatment solution may further contain a liquid medium. The liquid medium is preferably water from the viewpoint that a dispersion containing an aqueous medium as a dispersion medium, such as a resin emulsion, can be used for a raw material, and from the viewpoint of explosion resistance in producing the chemical conversion-treated steel pipe. The content of the liquid medium can be appropriately determined within a concentration range of the solid content suitable for application of the chemical conversion treatment solution.

The base resin is preferably used in an emulsion from the viewpoint of the productivity of the chemical conversion-treated steel pipe and safety in producing. The particle diameter of the emulsion of the base resin is preferably 10 to 100 nm from the viewpoint of enhancement of the water impermeability of the chemical conversion treatment coating film and enabling drying of the chemical conversion treatment solution at a lower temperature. When the particle diameter is smaller than 10 nm, the stability of the chemical conversion treatment solution may be lowered; and when the particle diameter is larger than 100 nm, the effect to enable drying of the chemical conversion treatment solution at a low temperature may be insufficient. From the same viewpoint, the fluororesin is preferably used in an emulsion, and the particle diameter of the emulsion of the fluororesin is preferably 10 to 300 nm.

The chemical conversion treatment solution may contain the materials for the chemical conversion treatment coating film as they are, or may contain precursors of the materials. A “precursor of the material” is a component which changes to the material in the chemical conversion treatment solution or changes through drying the chemical conversion treatment solution. Examples of the precursor include the pre-chemical conversion treatment component. Specific examples of the pre-chemical conversion treatment component include titanium salts such as KₙTiF₆ (K: alkali metal or alkali earth metal, n: 1 or 2), K₂[TiO(COO)₂], (NH₄)₂TiF₆, TiCl₄, TiOSO₄, Ti(SO₄)₂, and Ti(OH)₄; zirconium salts such as (NH₄)₂ZrF₆, Zr(SO₄)₂, and (NH₄)₂ZrO(CO₃)₂; and molybdenum salts such as (NH₄)₆MO₇O₂₄ and K₂(MoO₂F₄). These are precursors of the above valve metal compounds, and each of them can generate a hydroacid salt, ammonium salt, alkali metal salt, or alkali earth metal salt of a metal containing a valve metal through drying of the chemical conversion treatment solution.

In addition, the chemical conversion treatment solution may further contain an additive suitable for the chemical conversion treatment solution. Examples of the additive include a rheology-controlling agent, an etching agent, and a lubricant.

The rheology-controlling agent contributes to, for example, prevention of the settling of the metal flake in the chemical conversion treatment solution and enhancement of the dispersiveness of the metal flake in the chemical conversion treatment solution. The rheology-controlling agent is preferably one or more compounds selected from the group consisting of urethane compounds, acrylic compounds, polyolefins, amide compounds, anionic activating agents, nonionic activating agents, polycarboxylic acids, cellulose, metolose, and urea.

For the rheology-controlling agent, commercial products may be used. Examples of the commercial product include THIXOL K-130B and THIXOL W300 (manufactured by KYOEISHA CHEMICAL Co., LTD.); UH750 and SDX-1014 (manufactured by ADEKA CORPORATION); DISPARLON AQ-610 (manufactured by Kusumoto Chemicals, Ltd., “DISPARLON” is a registered trademark owned by the manufacturer); and BYK-425 and BYK-420 (manufactured by BYK-Chemie GmbH, “BYK” is a registered trademark owned by the manufacturer).

The etching agent activates the surface of the plated steel pipe and contributes to enhancement of the adhesion of the chemical conversion treatment coating film to the plated steel pipe. Examples of the etching agent include oxides and phosphates of Mg, Ca, Sr, V, W, Mn, B, Si or Sn. The etching agent is a precursor of the etching compound.

The lubricant contributes to increase in lubricity of the chemical conversion treatment coating film to enhance the processability of the chemical conversion-treated steel pipe. Examples of the lubricant include inorganic lubricants such as molybdenum disulfide and talc.

[Pretreatment Coating Film]

The plated steel sheet may further include a pretreatment coating film from the viewpoint of enhancement of the corrosion resistance of the chemical conversion-treated steel pipe and reduction of the gloss of the chemical conversion-treated steel pipe. The pretreatment coating film is a layer of a component attaching to the plated steel sheet as a result of treatment for a surface to form a chemical conversion treatment coating film. Accordingly, the pretreatment coating film is disposed on the surface of the plated steel sheet, and, in the chemical conversion-treated steel pipe, disposed between the surface of the plated steel sheet and the chemical conversion treatment coating film.

The pretreatment coating film contains a phosphate compound or a valve metal component. Examples of the valve metal component include Ti, Zr, Hf, V, Nb, Ta, Mo, and W. The valve metal component in the pretreatment coating film may be in the same state as in a pretreatment solution described later, or in a state different from that in the pretreatment solution. The valve metal is applied on the plated steel sheet, for example, in a salt state, and can be present in a state of an oxide, a hydroxide, or a fluoride in the pretreatment coating film. The amount of the valve metal component deposition in the pretreatment coating film (in terms of metal elements) is preferably 0.1 to 500 mg/m² and more preferably 0.5 to 200 mg/m² from the viewpoint of the corrosion resistance and adhesion, etc,

Examples of the phosphate compound include orthophosphate salts and polyphosphate salts of metals. The phosphate compound is, for example, present as a soluble or poorly-soluble metal phosphate or composite phosphate in the pretreatment coating film. Examples of the metal of the soluble metal phosphate salt or composite phosphate salt include alkali metals, alkali earth metals, and Mn. Examples of the metal of the poorly-insoluble metal phosphate salt or composite phosphate salt include Al, Ti, Zr, Hf, and Zn. The content of the phosphate compound in the pretreatment coating film (in terms of phosphorus element) is preferably 0.5 to 500 mg/m² and more preferably 1.0 to 200 mg/m² from the viewpoint of the corrosion resistance and adhesion, etc.

The presence of the pretreatment coating film can be confirmed through detection of an element specific to the phosphate compound or valve metal when the boundary portion between the chemical conversion treatment coating film and the plated steel pipe is subjected to element analysis such as X-ray fluorescence spectrometry, electron spectroscopy for chemical analysis (ESCA), and glow discharge spectroscopy (GDS).

The pretreatment coating film is produced by applying a pretreatment solution containing a valve metal salt to become an oxide, hydroxide, or fluoride of a valve metal and the phosphate compound on the surface of the plated steel sheet followed by drying. Examples of the valve metal salt include titanates such as KₙTiF₆ (K: alkali metal or alkali earth metal, n: 1 or 2), K₂[TiO(COO)₂], (NH₄)₂TiF₆, TiCl₄, TiOSO₄, Ti(SO₄)₂, and Ti(OH)₄; zirconates such as (NH₄)₂ZrF₆, Zr(SO₄)₂ and (NH₄)₂ZrO(CO₃)₂; and molybdates such as (NH₄)₆MO₇O₂₄ and K₂(MoO₂F₄).

The pretreatment solution may further contain an additional component other than the valve metal salt and the phosphate compound. For example, the pretreatment solution may further contain an organic acid having a chelating function. The organic acid contributes to stabilization of the valve metal salt. Examples of the organic acid include tartaric acid, tannic acid, citric acid, oxalic acid, malonic acid, lactic acid, acetic acid, and ascorbic acid. The content of the organic acid in the pretreatment solution is, for example, 0.02 or more in mole ratio of the organic acid to the valve metal ion.

The pretreatment solution can be applied on the plated steel sheet by using a known method such as a roll coating method, a spin coating method, a spraying method, and a dipping method. The amount of the pretreatment solution to be applied is preferably an amount such that the amount of the valve metal to be deposited is 0.5 mg/m² or more. The amount of the pretreatment solution to be applied is preferably an amount such that the thickness of a pretreatment coating film to be formed is 3 to 2,000 nm or smaller. When the thickness is smaller than 3 nm, the corrosion resistance by the pretreatment coating film may be developed insufficiently; and when the thickness is larger than 2,000 nm, a crack may be generated in the pretreatment coating film due to a stress in molding processing of the plated steel sheet.

The pretreatment coating film is produced, for example, by drying the applied film of the pretreatment solution formed on the surface of the plated steel sheet without washing with water. The applied film may be dried at normal temperature, but is preferably dried at a temperature of 50° C. or higher from the viewpoint of productivity (continuous operation). The drying temperature is preferably 200° C. or lower from the viewpoint of preventing the components in the pretreatment solution from being thermally decomposed.

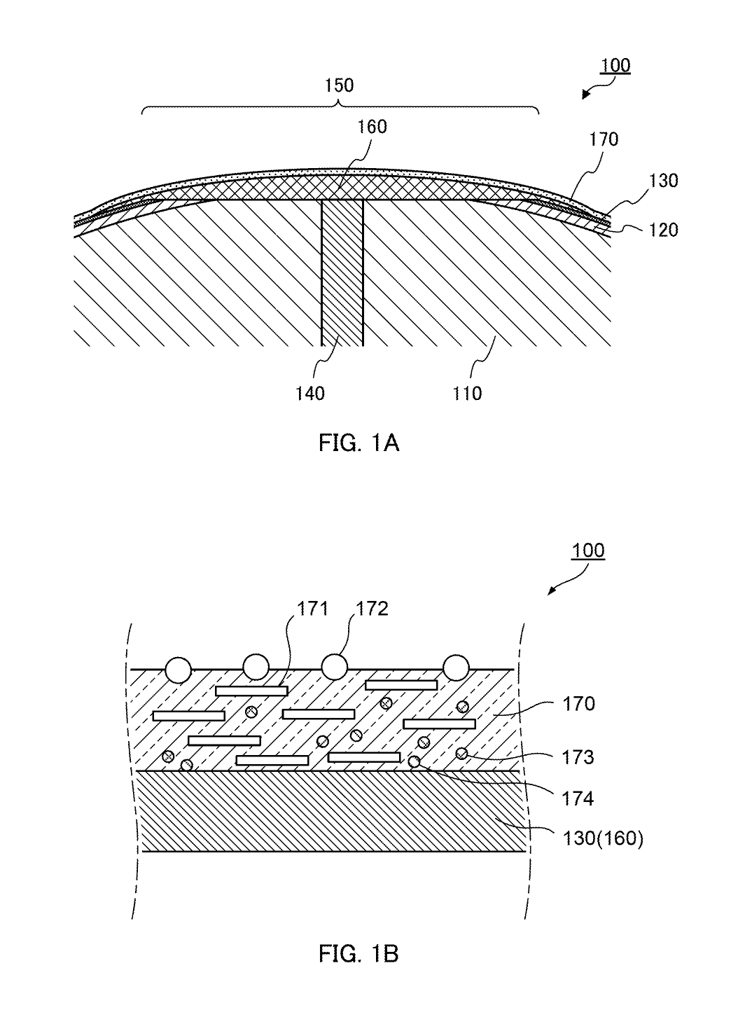

FIGS. 1A and 1B illustrate the layered structure of the chemical conversion-treated steel pipe. FIG. 1A schematically illustrates the layered structure of the chemical conversion-treated steel pipe according to one embodiment of the present invention, and FIG. 1B schematically illustrates the layered structure in closeup.

Chemical conversion-treated steel pipe 100 has steel sheet 110, plating layer 120, pretreatment coating film 130, welded portion 140, bead-cut portion 150, thermal spray-repaired layer 160, and chemical conversion treatment coating film 170. Plating layer 120 is disposed on the surface of steel sheet 110, pretreatment coating film 130 is disposed on the surface of plating layer 120, and chemical conversion treatment coating film 170 is disposed on the surface of pretreatment coating film 130. At the same time, chemical conversion-treated steel pipe 100 has welded portion 140, and thermal spray-repaired layer 160 is disposed to cover welded portion 140. Thermal spray-repaired layer 160 is covered with chemical conversion treatment coating film 170. In this way, chemical conversion treatment coating film 170 covers the surface of plating layer 120 via pretreatment coating film 130, and covers thermal spray-repaired layer 160.

Plating layer 120 is composed of, for example, a zinc alloy containing aluminum and magnesium. Chemical conversion treatment coating film 170 has a layered structure of the fluororesin and the base resin (not illustrated), and the thickness of chemical conversion treatment coating film 170 is, for example, 1 to 4 μm. Chemical conversion treatment coating film 170 contains, for example, metal flake 171, wax 172, valve metal compound 173, and silane coupling agent 174.

The content of the fluororesin relative to the total amount of the fluororesin and the base resin in chemical conversion treatment coating film 170 is 3.0 mass % or more in terms of fluorine atoms, and the mass ratio of the fluororesin to the base resin is, for example, 1:3. Chemical conversion treatment coating film 170 contains a sufficient amount of the fluororesin, which allows chemical conversion-treated steel pipe 100 to exhibit a good weatherability.

Chemical conversion treatment coating film 170 also contains a sufficient amount of the base resin, which allows chemical conversion treatment coating film 170 to have a good adhesion to plating layer 120. The content of metal flake 171 in chemical conversion treatment coating film 170 is, for example, 20 mass %. A plurality of metal flakes 171 are overlapped in the thickness direction of chemical conversion treatment coating film 170, and the distribution of metal flakes 171 in chemical conversion treatment coating film 170 is generally homogeneous when viewed in the plane direction of chemical conversion treatment coating film 170. Although a part of plating layer 170 is not covered with metal flake 171, an almost entire area of plating layer 170 is covered. This configuration moderately suppresses the gloss of chemical conversion-treated steel pipe 100. In addition, the base resin and metal flakes 171 are homogeneously distributed in the plane direction of chemical conversion treatment coating film 170, and by virtue of this configuration the change of appearance of chemical conversion-treated steel pipe 100 is suppressed even when plating layer 120 is blackened.

The reason why the blackening of the plating layer is suppressed is presumably as follows. The fluororesin and the base resin in the matrix of chemical conversion treatment coating film are substantially uniform, but the boundary between the fluororesin and the base resin can serve as a pathway for liquid due to the strong liquid repellency of the fluororesin. A secretion such as perspiration from a worker entering the pathway reaches the plating layer to oxidize Mg in the plating layer, which causes the above-mentioned blackening of the plating layer.

The chemical conversion treatment coating film has metal flakes. The metal flakes are disposed in the chemical conversion treatment coating film so as to cover an almost entire area of the plating layer as described above. This configuration allows the pathway to extend while circumventing the metal flakes in the thickness direction of the chemical conversion treatment coating film, and as a result the pathway has a large length. Thus, the secretion is less likely to reach the plating layer. Even when the secretion reaches the plating layer to cause the blackening of the plating layer, the metal flakes which cover an almost entire area of the plating layer hide the blackened portion from the outside, and as a result the blackened portion is not observed from the outside. Accordingly, the change of appearance in the chemical conversion-treated steel sheet due to the blackening of the plating layer can be suppressed.

As is clear from the above description, the chemical conversion-treated steel pipe according to the present embodiment includes a plated steel pipe produced by welding the plated steel sheet and a chemical conversion treatment coating film disposed on the surface of the plated steel pipe, and includes a steel sheet and a zinc alloy disposed on the surface of the steel sheet and containing 0.05 to 60 mass % of aluminum and 0.1 to 10.0 mass % of magnesium; the chemical conversion treatment coating film contains a fluororesin, a base resin, a metal flake, and a chemical conversion treatment component; the base resin is one or more selected from the group consisting of a polyurethane, a polyester, an acrylic resin, an epoxy resin, and a polyolefin; the content of the fluororesin relative to the total amount of the fluororesin and the base resin is 3.0 mass % or more in terms of fluorine atoms; the content of the base resin relative to 100 parts by mass of the fluororesin in the chemical conversion treatment coating film is 10 parts by mass or more; and the content of the metal flake in the chemical conversion treatment coating film is more than 20 mass % and 60 mass % or less. This configuration allows the chemical conversion-treated steel pipe to have sufficient weatherability and adhesion of the chemical conversion treatment coating film and exhibit suppressed gloss and suppressed discoloration over time.

The configuration in which the metal flake is one or more selected from the group consisting of an aluminum flake, an aluminum alloy flake, and a stainless steel flake, is even more effective from the viewpoint of corrosion resistance and high designability.

The configuration in which the thickness of the chemical conversion treatment coating film is 0.5 to 10 μm, is even more effective from the viewpoint of allowing the chemical conversion treatment coating film to exert the expected function and enhancement of the productivity.

The configuration in which the content of the base resin relative to 100 parts by mass of the fluororesin in the chemical conversion treatment coating film is 900 parts by mass or less, is even more effective from the viewpoint of the weatherability of the chemical conversion treatment coating film.

The configuration in which the chemical conversion treatment component contains a valve metal compound including one or more selected from the group consisting of Ti, Zr, Hf, V, Nb, Ta, Mo, and W, and the content of the valve metal compound based on the chemical conversion treatment coating film is 0.005 to 5.0 mass % in terms of metal, is even more effective from the viewpoint of enhancement of the corrosion resistance of the chemical conversion-treated steel pipe, fixation of the metal flake in the chemical conversion treatment coating film, and the processability of the chemical conversion treatment coating film.

The configuration in which the chemical conversion treatment coating film further contains one or both of a silane coupling agent and a phosphate salt, is even more effective from the viewpoint of enhancement of the corrosion resistance of the chemical conversion-treated steel pipe.

The configuration in which the plated steel sheet has been pretreated with a phosphate compound or a valve metal component and the valve metal component is one or more selected from the group consisting of Ti, Zr, Hf, V, Nb, Ta, Mo, and W, is even more effective from the viewpoint of enhancement of the corrosion resistance of the chemical conversion-treated steel pipe.

In addition, the configuration in which the plated steel pipe further includes a thermal spray-repaired layer covering a welded portion of the plated steel pipe and the Al concentration in the surface of the thermal spray-repaired layer is 0.05 atom % or more, is even more effective from the viewpoint of enhancement of the corrosion resistance of the chemical conversion-treated steel pipe.

The configuration in which the chemical conversion treatment coating film further contains a pigment, is even more effective from the viewpoint of suppression of the discoloration of the chemical conversion-treated steel pipe.

The configuration in which the chemical conversion treatment coating film further contains a wax, is even more effective from the viewpoint of enhancement of the processability of the chemical conversion-treated steel pipe.

In addition, the chemical conversion-treated steel pipe is suitable for a steel pipe for a building frame of an agricultural greenhouse.

As described above, the chemical conversion-treated steel pipe is excellent in weatherability. Accordingly, the chemical conversion-treated steel pipe is suitable for exterior building materials. In addition, the chemical conversion-treated steel pipe has an excellent effect to prevent gloss and discoloration over time, and further can prevent blackening due to other factors, such as blackening due to the attachment of perspiration from, for example, a worker handling an exterior building material. Thus, the chemical conversion-treated steel pipe keeps the beautiful appearance, and is also effective for enhancement of workability in exterior finishing with an exterior building material using the chemical conversion-treated steel pipe.

Hereinafter, the present invention will be described in detail with reference to Examples, but the present invention is never limited to these Examples.

### EXAMPLES

[Production of Al-Containing Zn Alloy-Plated Steel Sheet]

Using an SPCC having a sheet thickness of 0.8 mm as a base material, a hot-dip Zn-6 mass % Al-3 mass % Mg alloy-plated steel sheet (hereinafter, also referred to as “plated steel sheet A”) was produced. The amount of plating deposition of plated steel sheet A was 45 g/m².

Using an SPCC having a sheet thickness of 0.8 mm as a base material, plated steel sheets B to E as hot-dip Zn—Al—Mg alloy-plated steel sheets were produced in the same manner as in the case of plated steel sheet A except that the contents of Zn, Al, and Mg in the plating alloy were changed as shown in Table 1 and the amount of plating deposition was changed as shown in Table 1.

Further, plated steel sheets F and G as hot-dip Zn—Al alloy-plated steel sheets were produced in the same manner as in the case of plated steel sheet A except that the contents of Zn and Al in the plating alloy were changed as shown in Table 1 and the amount of plating deposition was changed as shown in Table 1.

The composition of a plating alloy and the amount of plating layer deposition for plated steel sheets B to G are shown in Table 1. In Table 1, “Al content” refers to the amount in mass % of aluminum in the plating layer, and “Mg content” refers to the amount in mass % of magnesium in the plating layer.

TABLE 1

| | | | Amount of plating |
|---|---|---|---|
| Plated steel | Al content | Mg content | layer deposition |
| sheet | (mass %) | (mass %) | (g/m²) |
| B | 11 | 3.0 | 45 |
| C | 4.0 | 1.0 | 60 |
| D | 2.5 | 3.0 | 90 |
| E | 55 | 2.5 | 60 |
| F | 0.18 | — | 60 |
| G | 55 | — | 45 |

[Preparation of Pretreatment Solution]

(Preparation of Pretreatment Solution B1)

By mixing (NH₄)₆MO₇O₂₄.4H₂O, phosphoric acid, and water together, pretreatment solution B1 was obtained. The Mo atom content and P atom content of pretreatment solution B1 are 30 g/L and 45 g/L, respectively.

(Preparation of Pretreatment Solution B2)

By mixing V₂O₅, NH₄H₂PO₄, and water together, pretreatment solution B2 was obtained. The V atom content and P atom content of pretreatment solution B2 are 30 g/L and 45 g/L, respectively.

(Preparation of Pretreatment Solution B3)

By mixing (NH₄)₂ZrO(CO₃)₂, phosphoric acid, and water together, pretreatment solution B3 was obtained. The Zr atom content and P atom content of pretreatment solution B3 are 30 g/L and 45 g/L, respectively.

(Preparation of Pretreatment Solution B4)

By mixing (NH₄)₂TiF₆, phosphoric acid, and water together, pretreatment solution B4 was obtained. The Ti atom content and P atom content of pretreatment solution B4 are 30 g/L and 45 g/L, respectively.

The composition for pretreatment solutions B1 to B4 are shown in Table 2. In Table 2, “BM” denotes valve metal.

TABLE 2

| | Valve metal | | | Phosphate compound | |
|---|---|---|---|---|---|
| Treatment | | | BM concen- | | P concen- |
| solution | BM | | tration | Phosphate | tration |
| No. | salt | BM | (g/L) | salt | (g/L) |
| B1 | (NH₄)₆Mo₇O₂₄•4H₂O | Mo | 30 | H₃PO₄ | 45 |
| B2 | V₂O₅ | V | 30 | NH₄H₂PO₄ | 45 |
| B3 | (NH₄)₂ZrO(CO₃)₂ | Zr | 30 | H₃PO₄ | 45 |
| B4 | (NH₄)₂TiF₆ | Ti | 30 | H₃PO₄ | 45 |

[Preparation of Chemical Conversion Treatment Solution]

(Preparation of Materials)

The following materials were prepared.

(1) Resin Emulsion

An “fluororesin emulsion” is an aqueous emulsion of a fluororesin (Tg: −35 to 25° C., minimum film-forming temperature (MFT): 10° C., FR), the concentration of the solid content of the fluororesin emulsion is 38 mass %, the fluorine atom content in the fluororesin is 25 mass %, and the average particle diameter of the emulsion is 150 nm.

For an emulsion of a urethane resin (PU), a “HYDRAN” manufactured by DIC Corporation was prepared. The concentration of the solid content of the “HYDRAN” is 35 mass %. The average particle diameter of the emulsion is estimated to be approximately 10 to 100 nm.

For an emulsion of an acrylic resin (AR), a “PATELACOL” manufactured by DIC Corporation (a registered trademark owned by the manufacturer) was prepared. The concentration of the solid content of the “PATELACOL” is 40 mass %. The average particle diameter of the emulsion is estimated to be approximately 10 to 100 nm.

For an emulsion of a polyester (PE), a “VYLONAL” manufactured by TOYOBO STC CO., LTD. was prepared. The concentration of the solid content of the “VYLONAL” is 30 mass %. The average particle diameter of the emulsion is estimated to be approximately 10 to 100 nm.

For an emulsion of an epoxy resin (ER), an “ADEKA RESIN” manufactured by ADEKA CORPORATION was prepared (a registered trademark owned by the manufacturer). The concentration of the solid content of the “ADEKA RESIN” is 30 mass %. The average particle diameter of the emulsion is estimated to be approximately 10 to 100 nm.

For an emulsion of a polyolefin (PO), an “ARROWBASE” manufactured by UNITIKA LTD. (a registered trademark owned by the manufacturer) was prepared. The concentration of the solid content of the “ARROWBASE” is 25 mass %. The average particle diameter of the emulsion is estimated to be approximately 10 to 100 nm.

(2) Metal Flake

For an aluminum flake, a “WXM-U75C” manufactured by TOYO ALUMINIUM K.K. was prepared. The average particle diameter and average thickness of the aluminum flake are 18 μm and 0.2 μm, respectively.

For a stainless steel flake, a “PFA4000” manufactured by TOYO ALUMINIUM K.K. was prepared. The average particle diameter and average thickness of the stainless steel flake are 40 μm and 0.5 μm, respectively.

(3) Pre-Chemical Conversion Treatment Component

For a titanium compound (Ti), “H₂TiF₆ (40% aqueous solution)” was prepared. The Ti atom content in H₂TiF₆ (40%) is 11.68 mass %.

For a zirconium compound (Zr), “Zircosol AC-7” manufactured by DAIICHI KIGENSO KAGAKU KOGYO CO., LTD. was prepared. The Zr atom content in the Zircosol AC-7 is 9.62 mass %. “Zircosol” is registered trademark owned by the manufacturer.

For a vanadium compound (V), ammonium metavanadate (NH₄VO₃) was prepared. The V atom content in ammonium metavanadate is 43.55 mass %.

For a molybdate compound (Mo), ammonium molybdate ((NH₄)₆Mo₇O₂₄.4H₂O) was prepared. The Mo atom content in ammonium molybdate is 54.35 mass %.

(4) Additives

For a wax, a “Hitech” manufactured by TOHO Chemical Industry Co., Ltd. was prepared. The melting point of the wax is 120° C.

For a rheology-controlling agent (RCA), a “BYK-420” manufactured by BYK-Chemie GmbH was prepared. “BYK” is a registered trademark owned by the manufacturer.

For pigment A (silica), a “LIGHTSTAR” manufactured by NISSAN CHEMICAL INDUSTRIES, LTD. was prepared. The average particle diameter of the “LIGHTSTAR” is 200 nm.

For pigment B (carbon black), a “Ketjenblack” manufactured by Lion Corporation was prepared. The average particle diameter of the “Ketjenblack” is 40 nm.

For pigment C (organic pigment), a “Styrene-acrylic resin” manufactured by NIPPONPAINT Co., Ltd. was prepared. The average particle diameter of the “Styrene-acrylic resin” is 500 nm.

For a phosphate compound, diammonium hydrogenphosphate ((NH₄)₂HPO₄)) was prepared. The P atom content in diammonium hydrogenphosphate is 23.44 mass %.

For a silane coupling agent (SCA), a “SILQUEST A-186” manufactured by Momentive Performance Materials Japan LLC. was prepared.

(Preparation of Chemical Conversion Treatment Solution 1)

The fluororesin emulsion, the urethane resin emulsion, the aluminum flake, the titanium compound, and water each in an appropriate amount were mixed together to obtain chemical conversion treatment solution 1. The content of the urethane resin relative to 100 parts by mass of the fluororesin in chemical conversion treatment solution 1 was 10 parts by mass. The content of the resins other than the fluororesin (also referred to as “base material content”) relative to 100 parts by mass of the fluororesin in chemical conversion treatment solution 1 was 10 parts by mass. The fluorine atom content (also referred to as “F content”) in the whole organic resin (the total amount of the fluororesin and the base resin) in chemical conversion treatment solution 1 was 22.7 mass %. The content of the metal flake (also referred to as “flake content”) relative to the solid content in chemical conversion treatment solution 1 was 25 mass %. The content of the titanium compound relative to the solid content in chemical conversion treatment solution 1 was 0.05 mass % in terms of Ti atoms.

(Preparation of Chemical Conversion Treatment Solution 2)

The fluororesin emulsion, the polyester emulsion, the aluminum flake, the titanium compound, the phosphate compound, and water each in an appropriate amount were mixed together to obtain chemical conversion treatment solution 2. The content of the polyester relative to 100 parts by mass of the fluororesin in chemical conversion treatment solution 2 was 100 parts by mass, the content of the titanium compound relative to the solid content in chemical conversion treatment solution 2 was 0.20 mass % in terms of Ti atoms, and the content of the phosphate compound relative to the solid content in chemical conversion treatment solution 2 was 0.6 mass % in terms of P atoms. The base material content in chemical conversion treatment solution 2 was 100 parts by mass. The fluorine atom content of chemical conversion treatment solution 2 was 12.5 mass %. The flake content in chemical conversion treatment solution 2 was 40 mass %.

(Preparation of Chemical Conversion Treatment Solution 3)

Chemical conversion treatment solution 3 was obtained in the same manner as in the case of chemical conversion treatment solution 2 except that the phosphate compound was not added, the zirconium compound was added in place of the titanium compound, the amount of the aluminum flake to be added was changed, and the rheology-controlling agent was added. The base material content in chemical conversion treatment solution 3 was 100 parts by mass. The fluorine atom content in chemical conversion treatment solution 3 was 12.5 mass %. The flake content in chemical conversion treatment solution 3 was 60 mass %, and the content of the rheology-controlling agent was 0.5 mass %.

(Preparation of Chemical Conversion Treatment Solution 4)

Chemical conversion treatment solution 4 was obtained in the same manner as in the case of chemical conversion treatment solution 3 except that the amount of the aluminum flake to be added was changed, the vanadium compound was added in place of the zirconium compound, and pigment C was added. The base material content in chemical conversion treatment solution 4 was 100 parts by mass. The fluorine atom content in chemical conversion treatment solution 4 was 12.5 mass %. The flake content in chemical conversion treatment solution 4 was 30 mass %. The content of pigment C relative to the solid content in chemical conversion treatment solution 4 was 0.5 mass %.

(Preparation of Chemical Conversion Treatment Solution 5)

The fluororesin emulsion, the urethane resin emulsion, the acrylic resin emulsion, the polyester emulsion, the polyolefin emulsion, the aluminum flake, the titanium compound, the wax, and water each in an appropriate amount were mixed together to obtain chemical conversion treatment solution 5. The content of the urethane resin relative to 100 parts by mass of the fluororesin in chemical conversion treatment solution 5 was 100 parts by mass, the contents of the acrylic resin, the polyester, and the polyolefin relative to 100 parts by mass of the fluororesin in chemical conversion treatment solution 5 were each 25 parts by mass, and the content of the wax relative to the solid content in chemical conversion treatment solution 5 was 2.0 mass %. The base material content in chemical conversion treatment solution 5 was 175 parts by mass. The fluorine atom content in chemical conversion treatment solution 5 was 9.1 mass %. The flake content in chemical conversion treatment solution 5 was 30 mass %. The content of the titanium compound relative to the solid content in chemical conversion treatment solution 5 was 0.05 mass % in terms of Ti atoms.

(Preparation of Chemical Conversion Treatment Solution 6)

The fluororesin emulsion, the urethane resin emulsion, the acrylic resin emulsion, the polyester emulsion, the epoxy resin emulsion, the polyolefin emulsion, the aluminum flake, the wax, the zirconium compound, and water each in an appropriate amount were mixed together to obtain chemical conversion treatment solution 6. The content of the urethane resin relative to 100 parts by mass of the fluororesin in chemical conversion treatment solution 6 was 300 parts by mass, the contents of the acrylic resin, the polyester, and the epoxy resin relative to 100 parts by mass of the fluororesin in chemical conversion treatment solution 6 were each 100 parts by mass, and the content of the polyolefin was 50 parts by mass. The content of the wax relative to the solid content in chemical conversion treatment solution 6 was 2.0 mass %, and the content of the zirconium compound relative to the solid content in chemical conversion treatment solution 6 was 0.20 mass % in terms of Zr atoms. The base material content in chemical conversion treatment solution 6 was 650 parts by mass. The fluorine atom content in chemical conversion treatment solution 6 was 3.3 mass %. The flake content in chemical conversion treatment solution 6 was 25 mass %.

(Preparation of Chemical Conversion Treatment Solution 7)

The fluororesin emulsion, the urethane resin emulsion, the acrylic resin emulsion, the aluminum flake, the wax, the zirconium compound, the phosphate compound, the silane coupling agent, the rheology-controlling agent, and water each in an appropriate amount were mixed together to obtain chemical conversion treatment solution 7. The contents of the urethane resin and the acrylic resin relative to 100 parts by mass of the fluororesin in chemical conversion treatment solution 7 were each 150 parts by mass, the content of the wax relative to the solid content in chemical conversion treatment solution 7 was 2.5 mass %, the content of the zirconium compound relative to the solid content in chemical conversion treatment solution 7 was 1.00 mass % in terms of Zr atoms, the content of the phosphate compound relative to the solid content in chemical conversion treatment solution 7 was 0.6 mass % in terms of P atoms, the content of the silane coupling agent relative to the solid content in chemical conversion treatment solution 7 was 1.5 mass %, and the content of the rheology-controlling agent was 0.5 mass %. The base material content in chemical conversion treatment solution 7 was 300 parts by mass. The fluorine atom content in chemical conversion treatment solution 7 was 6.3 mass %. The flake content in chemical conversion treatment solution 7 was 30 mass %.

(Preparation of Chemical Conversion Treatment Solution 8)

The fluororesin emulsion, the urethane resin emulsion, the polyester emulsion, the epoxy resin emulsion, the polyolefin emulsion, the aluminum flake, the titanium compound, the phosphate compound, the silane coupling agent, and water each in an appropriate amount were mixed together to obtain chemical conversion treatment solution 8. The contents of the urethane resin, the polyester, the epoxy resin, and the polyolefin relative to 100 parts by mass of the fluororesin in chemical conversion treatment solution 8 were each 25 parts by mass, the content of the titanium compound relative to the solid content in chemical conversion treatment solution 8 was 0.20 mass % in terms of Ti atoms, the content of the phosphate compound relative to the solid content in chemical conversion treatment solution 8 was 0.6 mass % in terms of P atoms, and the content of the silane coupling agent relative to the solid content in chemical conversion treatment solution 8 was 1.5 mass %. The base material content in chemical conversion treatment solution 8 was 100 parts by mass. The fluorine atom content in chemical conversion treatment solution 8 was 12.5 mass %. The flake content in chemical conversion treatment solution 8 was 30 mass %.

(Preparation of Chemical Conversion Treatment Solution 9)

The fluororesin emulsion, the urethane resin emulsion, the acrylic resin emulsion, the polyester emulsion, the polyolefin emulsion, the stainless steel flake, the zirconium compound, and water each in an appropriate amount were mixed together to obtain chemical conversion treatment solution 9. The content of the urethane resin relative to 100 parts by mass of the fluororesin in chemical conversion treatment solution 9 was 50 parts by mass, the contents of the acrylic resin, the polyester, and the polyolefin relative to 100 parts by mass of the fluororesin in chemical conversion treatment solution 9 were each 25 parts by mass, and the content of the zirconium compound relative to the solid content in chemical conversion treatment solution 9 was 0.50 mass % in terms of Zr atoms. The base material content in chemical conversion treatment solution 9 was 125 parts by mass. The fluorine atom content in chemical conversion treatment solution 9 was 11.1 mass %. The flake content in chemical conversion treatment solution 9 was 30 mass %.

(Preparation of Chemical Conversion Treatment Solution 10)

Chemical conversion treatment solution 10 was obtained in the same manner as in the case of chemical conversion treatment solution 9 except that an appropriate amount of the aluminum flake was used in place of the stainless steel flake, the amount of the zirconium compound to be added was changed, and an appropriate amount of pigment A (silica) was used. The content of pigment A relative to the solid content in chemical conversion treatment solution 10 was 0.5 mass % with respect to 100 parts by mass of the fluororesin. The base material content in chemical conversion treatment solution 10 was 125 parts by mass. The fluorine atom content in chemical conversion treatment solution 10 was 11.1 mass %. The flake content in chemical conversion treatment solution 10 was 20 mass %. The content of the zirconium compound relative to the solid content in chemical conversion treatment solution 10 was 0.20 mass % in terms of Zr atoms.

(Preparation of Chemical Conversion Treatment Solution 11)

Chemical conversion treatment solution 11 was obtained in the same manner as in the case of chemical conversion treatment solution 10 except that the amounts of the urethane resin emulsion and the aluminum flake to be added were changed, the titanium compound was used in place of the zirconium compound, and pigment B (carbon black) was used in place of pigment A in appropriate amounts, respectively. The content of the urethane resin relative to 100 parts by mass of the fluororesin in chemical conversion treatment solution 11 was 20 parts by mass, and the content of pigment B relative to the solid content in chemical conversion treatment solution 11 was 0.2 mass %. The base material content in chemical conversion treatment solution 11 was 95 parts by mass. The fluorine atom content in chemical conversion treatment solution 11 was 12.8 mass %. The flake content in chemical conversion treatment solution 11 was 25 mass %.

(Preparation of Chemical Conversion Treatment Solution 12)

The fluororesin emulsion, the urethane resin emulsion, the acrylic resin emulsion, the polyester emulsion, the epoxy resin emulsion, the aluminum flake, the stainless steel flake, the molybdate compound, pigment C (organic pigment), and water each in an appropriate amount were mixed together to obtain chemical conversion treatment solution 12. The content of the urethane resin relative to 100 parts by mass of the fluororesin in chemical conversion treatment solution 12 was 50 parts by mass, the contents of the acrylic resin, the polyester, and the epoxy resin relative to 100 parts by mass of the fluororesin in chemical conversion treatment solution 12 were each 25 parts by mass, the content of the molybdate compound relative to the solid content in chemical conversion treatment solution 12 was 0.01 mass % in terms of Mo atoms, and the content of pigment C relative to the solid content in chemical conversion treatment solution 12 was 0.5 mass %. The base material content in chemical conversion treatment solution 12 was 125 parts by mass. The fluorine atom content in chemical conversion treatment solution 12 was 11.1 mass %. The flake content in chemical conversion treatment solution 12 was 50 mass %. The content of the aluminum flake was 30 mass % and the content of the stainless steel flake was 20 mass %.

(Preparation of Chemical Conversion Treatment Solution 13)

Chemical conversion treatment solution 13 was obtained in the same manner as in the case of chemical conversion treatment solution 12 except that the polyolefin emulsion was used in place of the acrylic resin emulsion, the amount of the stainless steel flake to be added was changed, the amount of the molybdate compound to be added was changed, and an appropriate amount of the wax was used as an additive. The content of the urethane resin relative to 100 parts by mass of the fluororesin in chemical conversion treatment solution 13 was 50 parts by mass, the contents of the polyester, the epoxy resin, and the polyolefin relative to 100 parts by mass of the fluororesin in chemical conversion treatment solution 13 were each 25 parts by mass, and the content of the wax relative to the solid content in chemical conversion treatment solution 13 was 2.0 mass %. The base material content in chemical conversion treatment solution 13 was 125 parts by mass. The fluorine atom content in chemical conversion treatment solution 13 was 11.1 mass %. The flake content in chemical conversion treatment solution 13 was 35 mass %. The content of the aluminum flake was 30 mass % and the content of the stainless steel flake was 5 mass %.

The content of the molybdate compound relative to the solid content in chemical conversion treatment solution 13 was 2.00 mass % in terms of Mo atoms.

(Preparation of Chemical Conversion Treatment Solution 14)

Chemical conversion treatment solution 14 was obtained in the same manner as in the case of chemical conversion treatment solution 9 except that the aluminum flake was used in place of the stainless steel flake, an appropriate amount of the vanadium compound was used in place of the zirconium compound, and an appropriate amount of the silane coupling agent was used. The content of the silane coupling agent relative to the solid content in chemical conversion treatment solution 14 was 1.5 mass % with respect to 100 parts by mass of the fluororesin. The base material content in chemical conversion treatment solution 14 was 125 parts by mass. The fluorine atom content in chemical conversion treatment solution 14 was 11.1 mass %. The flake content in chemical conversion treatment solution 14 was 30 mass %. The content of the vanadium compound relative to the solid content in chemical conversion treatment solution 14 was 3.00 mass % in terms of V atoms.

(Preparation of Chemical Conversion Treatment Solution 15)

The fluororesin emulsion, the urethane resin emulsion, the acrylic resin emulsion, the polyester emulsion, the epoxy resin emulsion, the polyolefin emulsion, the aluminum flake, the titanium compound, pigment A, pigment C, and water each in an appropriate amount were mixed together to obtain chemical conversion treatment solution 15. The content of the urethane resin relative to 100 parts by mass of the fluororesin in chemical conversion treatment solution 15 was 50 parts by mass, the contents of the acrylic resin and the polyester relative to 100 parts by mass of the fluororesin in chemical conversion treatment solution 15 were each 25 parts by mass, the content of the epoxy resin relative to 100 parts by mass of the fluororesin in chemical conversion treatment solution 15 was 10 parts by mass, the content of the polyolefin relative to 100 parts by mass of the fluororesin in chemical conversion treatment solution 15 was 15 parts by mass, and the contents of pigment A and pigment C relative to the solid content in chemical conversion treatment solution 15 were each 0.5 mass %. The base material content in chemical conversion treatment solution 15 was 125 parts by mass. The fluorine atom content in chemical conversion treatment solution 15 was 11.1 mass %. The flake content in chemical conversion treatment solution 15 was 25 mass %. The content of the titanium compound relative to the solid content in chemical conversion treatment solution 15 was 0.20 mass % in terms of Ti atoms.

(Preparation of Chemical Conversion Treatment Solution 16)

Chemical conversion treatment solution 16 was obtained in the same manner as in the case of chemical conversion treatment solution 10 except that the amount of the aluminum flake to be added was changed, the amount of the zirconium compound to be added was changed, and pigment A was not added. The base material content in chemical conversion treatment solution 16 was 125 parts by mass. The fluorine atom content in chemical conversion treatment solution 16 was 11.1 mass %. The flake content in chemical conversion treatment solution 16 was 25 mass %. The content of the zirconium compound relative to the solid content in chemical conversion treatment solution 16 was 0.50 mass % in terms of Zr atoms.

(Preparation of Chemical Conversion Treatment Solution 17)

Chemical conversion treatment solution 17 was obtained in the same manner as in the case of chemical conversion treatment solution 4 except that the titanium compound was used in place of the vanadium compound, and the polyester emulsion and pigment C were not added. The base material content in chemical conversion treatment solution 17 was 0 parts by mass. The fluorine atom content in chemical conversion treatment solution 17 was 25.0 mass %. The flake content in chemical conversion treatment solution 17 was 30 mass %.

(Preparation of Chemical Conversion Treatment Solution 18)

The urethane resin emulsion, the polyester emulsion, the polyolefin emulsion, the aluminum flake, the zirconium compound, and water each in an appropriate amount were mixed together to obtain chemical conversion treatment solution 18. The contents of the polyester and the polyolefin relative to 50 parts by mass of the urethane resin in chemical conversion treatment solution 18 were each 25 parts by mass. The base material content in chemical conversion treatment solution 18 was 100 parts by mass. The fluorine atom content in chemical conversion treatment solution 18 was 0 mass %. The flake content in chemical conversion treatment solution 18 was 30 mass %. The content of the zirconium compound relative to the solid content in chemical conversion treatment solution 18 was 0.20 mass % in terms of Zr atoms.

(Preparation of Chemical Conversion Treatment Solution 19)

The acrylic resin emulsion, the polyester emulsion, the epoxy resin emulsion, the polyolefin emulsion, the aluminum flake, the vanadium compound and, water each in an appropriate amount were mixed together to obtain chemical conversion treatment solution 19. The contents of the polyester, the epoxy resin, and the polyolefin relative to 25 parts by mass of the acrylic resin in chemical conversion treatment solution 19 were each 25 parts by mass. The base material content in chemical conversion treatment solution 19 was 100 parts by mass. The fluorine atom content in chemical conversion treatment solution 19 was 0 mass %. The flake content in chemical conversion treatment solution 19 was 30 mass %. The content of the vanadium compound relative to the solid content in chemical conversion treatment solution 19 was 0.20 mass % in terms of V atoms.

(Preparation of Chemical Conversion Treatment Solution 20)

Chemical conversion treatment solution 20 was obtained in the same manner as in the case of chemical conversion treatment solution 16 except that an appropriate amount of the titanium compound was used in place of the zirconium compound, and the amount of the aluminum flake to be added was changed. The base material content in chemical conversion treatment solution 20 was 125 parts by mass. The fluorine atom content in chemical conversion treatment solution 20 was 11.1 mass %. The flake content in chemical conversion treatment solution 20 was 5 mass %. The content of the titanium compound relative to the solid content in chemical conversion treatment solution 20 was 0.20 mass % in terms of Ti atoms.

(Preparation of Chemical Conversion Treatment Solution 21)

Chemical conversion treatment solution 21 was obtained in the same manner as in the case of chemical conversion treatment solution 16 except that the amount of the zirconium compound to be added and the amount of the aluminum flake to be added were changed. The base material content in chemical conversion treatment solution 21 was 125 parts by mass. The fluorine atom content in chemical conversion treatment solution 21 was 11.1 mass %. The flake content in chemical conversion treatment solution 21 was 65 mass %. The content of the zirconium compound relative to the solid content in chemical conversion treatment solution 21 was 0.20 mass % in terms of Zr atoms.

The compositions of chemical conversion treatment solutions 1 to 16 are listed in Table 3. The compositions of chemical conversion treatment solutions 17 to 21 are listed in Table 4.

TABLE 3

| Chemical | Organic resin | | | | | | | | Metal flake | | | Chemical conversion | | | |
|---|---|---|---|---|---|---|---|---|---|---|---|---|---|---|---|
| conversion | Content (part by mass) | | | | | | | | Content (mass %) | | | treatment component | | | |
| treatment | FR | PU | AR | PE | ER | PO | Total of | F content | Al | SUS | Total of | | Content | Additive | |
| solution No. | (A) | (B) | (C) | (D) | (E) | (F) | B to F | (mass %) | (a) | (b) | a and b | Element | (mass %) | Inorganic | Organic |
| 1 | 100 | 10 | 0 | 0 | 0 | 0 | 10 | 22.7 | 25 | 0 | 25 | Ti | 0.05 | — | — |
| 2 | 100 | 0 | 0 | 100 | 0 | 0 | 100 | 12.5 | 40 | 0 | 40 | Ti | 0.20 | P | — |
| 3 | 100 | 0 | 0 | 100 | 0 | 0 | 100 | 12.5 | 60 | 0 | 60 | Zr | 0.20 | — | RCA |
| 4 | 100 | 0 | 0 | 100 | 0 | 0 | 100 | 12.5 | 30 | 0 | 30 | V | 0.20 | — | Pigment |
| | | | | | | | | | | | | | | | C |
| | | | | | | | | | | | | | | | RCA |
| 5 | 100 | 100 | 25 | 25 | 0 | 25 | 175 | 9.1 | 30 | 0 | 30 | Ti | 0.05 | — | wax |
| 6 | 100 | 300 | 100 | 100 | 100 | 50 | 650 | 3.3 | 25 | 0 | 25 | Zr | 0.20 | — | wax |
| 7 | 100 | 150 | 150 | 0 | 0 | 0 | 300 | 6.3 | 30 | 0 | 30 | Zr | 1.00 | P, SCA | wax |
| | | | | | | | | | | | | | | | RCA |
| 8 | 100 | 25 | 0 | 25 | 25 | 25 | 100 | 12.5 | 30 | 0 | 30 | Ti | 0.20 | P, SCA | — |
| 9 | 100 | 50 | 25 | 25 | 0 | 25 | 125 | 11.1 | 0 | 30 | 30 | Zr | 0.50 | — | — |
| 10 | 100 | 50 | 25 | 25 | 0 | 25 | 125 | 11.1 | 20 | 0 | 20 | Zr | 0.20 | SiO₂ | — |
| 11 | 100 | 20 | 25 | 25 | 0 | 25 | 95 | 12.8 | 25 | 0 | 25 | Ti | 0.20 | CB | — |
| 12 | 100 | 50 | 25 | 25 | 25 | 0 | 125 | 11.1 | 30 | 20 | 50 | Mo | 0.01 | — | Pigment |
| | | | | | | | | | | | | | | | C |
| 13 | 100 | 50 | 0 | 25 | 25 | 25 | 125 | 11.1 | 30 | 5 | 35 | Mo | 2.00 | — | wax |
| 14 | 100 | 50 | 25 | 25 | 0 | 25 | 125 | 11.1 | 30 | 0 | 30 | V | 3.00 | SCA | — |
| 15 | 100 | 50 | 25 | 25 | 10 | 15 | 125 | 11.1 | 25 | 0 | 25 | Ti | 0.20 | SiO₂ | Pigment |
| | | | | | | | | | | | | | | | C |
| 16 | 100 | 50 | 25 | 25 | 0 | 25 | 125 | 11.1 | 25 | 0 | 25 | Zr | 0.50 | — | — |

TABLE 4

| | Organic resin | | | | | | | | Metal flake | | | | | |
|---|---|---|---|---|---|---|---|---|---|---|---|---|---|---|
| Chemical | Content (part by mass) | | | | | | | | Content (mass %) | | | Chemical conversion | | |
| conversion | | | | | | | Total | | | | Total | treatment component | | |
| treatment | FR | PU | AR | PE | ER | PO | of B to | F content | Al | SUS | of a | | Content | |
| solution No. | (A) | (B) | (C) | (D) | (E) | (F) | F | (mass %) | (a) | (b) | and b | Element | (mass %) | Additive |
| 17 | 100 | 0 | 0 | 0 | 0 | 0 | 0 | 25.0 | 30 | 0 | 30 | Ti | 0.20 | RCA |
| 18 | 0 | 50 | 0 | 25 | 0 | 25 | 100 | 0 | 30 | 0 | 30 | Zr | 0.20 | — |
| 19 | 0 | 0 | 25 | 25 | 25 | 25 | 100 | 0 | 30 | 0 | 30 | V | 0.20 | — |
| 20 | 100 | 50 | 25 | 25 | 0 | 25 | 125 | 11.1 | 5 | 0 | 5 | Ti | 0.20 | — |
| 21 | 100 | 50 | 25 | 25 | 0 | 25 | 125 | 11.1 | 65 | 0 | 65 | Zr | 0.20 | — |

### Example 1

An open pipe of plated steel sheet A was formed, and the peripheries of plated sheet A contacting each other were welded along the longitudinal direction of the open pipe by high-frequency welding to produce a plated steel pipe with a diameter of 25.4 mm. The welded portion of the plated steel pipe was then bead-cut, and a thermal spray-repaired layer with a width of 10 mm and an average amount of deposition of 10 μm was formed under thermal spray conditions C2 that the first layer of the thermal spray core line was Zn and the second layer of the thermal spray core line was Al. The center in the width direction of the thermal spray-repaired layer is the welded portion.

The average amount of deposition was determined as follows: the chemical conversion-treated steel pipe was cut in the direction perpendicular to the axial direction and the cross-section exposed was buried in a resin, and a photograph of the cross-section was taken so that the whole of the thermal spray-repaired layer was contained in the photograph; subsequently, the photograph was evenly divided into 30 sections along the width direction of the thermal spray-repaired layer to determine 30 observation positions; the thickness of the thermal spray-repaired layer was measured at each observation position and the thicknesses were averaged; and the average value was used as the average amount of deposition.

The plated steel pipe on which the thermal spray-repaired layer had been formed was washed with warm water, and chemical conversion treatment solution 1 was dropped on the surface of the plated steel pipe, and the surface was wiped with a sponge and dried with a dryer at 140° C. without being washed with water. Thus, chemical conversion-treated steel pipe 1 was produced. The thickness of the chemical conversion treatment coating film on chemical conversion-treated steel pipe 1 was 2.0 μm.

The thickness of the chemical conversion treatment coating film was determined as follows: the plated steel pipe was cut in the direction perpendicular to the axial direction and four test pieces in total including the cross-section of the plated steel pipe were cut out at positions of 0°, 90°, 180°, and 270° with reference to the welded position (0°) along the peripheral direction of the cross-section of the plated steel pipe; the test pieces were buried in a resin and photographs of the cross-sections were taken; subsequently, the thickness of the chemical conversion treatment coating film was measured at each of the positions in the photographs and the thicknesses were averaged; and the average value was used as the thickness of the chemical conversion treatment coating film. The thickness of the chemical conversion treatment coating film was adjusted through the amount of the chemical conversion treatment solution dropped and wiping with a sponge.

### Examples 2 to 20

Chemical conversion-treated steel pipes 2 to 20 were produced in the same manner as in the case of chemical conversion-treated steel pipe 1 except that the type of the chemical conversion treatment solution, drying temperature, and film thickness were changed as shown in Table 6.

### Example 21

Chemical conversion-treated steel pipe 21 was produced in the same manner as in the case of chemical conversion-treated steel pipe 20 except that a pretreatment coating film was formed on the surface of plated steel sheet A by using pretreatment solution B 1.

Then, pretreatment solution B1 was applied on the surface of plated steel sheet A, and heat-dried to a temperature of 100° C. to form a pretreatment coating film. The amount of molybdenum deposition in the pretreatment coating film is 30 mg/m². The amount of deposition is the same also in the case of other chemical conversion-treated steel pipes having a pretreatment coating film of pretreatment solution B 1.

### Examples 22 to 24

Chemical conversion-treated steel pipes 22 to 24 were produced in the same manner as in the case of chemical conversion-treated steel pipe 21 except that the type of the pretreatment solution was changed as shown in Table 6.

The amount of vanadium deposition in the pretreatment coating film on chemical conversion-treated steel pipe 22 is 30 mg/m². The amount of deposition is the same also in the case of other chemical conversion-treated steel pipes having a pretreatment coating film of pretreatment solution B2.

The amount of zirconium deposition in the pretreatment coating film on chemical conversion-treated steel pipe 23 is 30 mg/m². The amount of deposition is the same also in the case of other chemical conversion-treated steel pipes having a pretreatment coating film of pretreatment solution B3.

The amount of titanium deposition in the pretreatment coating film on chemical conversion-treated steel pipe 24 is 30 mg/m². The amount of deposition is the same also in the case of other chemical conversion-treated steel pipes having a pretreatment coating film of pretreatment solution B4.

### Examples 25 to 28

Chemical conversion-treated steel pipes 25 to 28 were produced in the same manner as in the case of chemical conversion-treated steel pipes 21 to 24, respectively, except that chemical conversion treatment solution 3 was used in place of chemical conversion treatment solution 16, and the thickness of the chemical conversion treatment coating film was changed to 0.5 μm.

### Example 29

Chemical conversion-treated steel pipe 29 was produced in the same manner as in the case of chemical conversion-treated steel pipe 2 except that a thermal spray-repaired layer was not formed.

### Examples 30 to 32

Chemical conversion-treated steel pipes 30 to 32 were produced in the same manner as in the case of chemical conversion-treated steel pipe 2 except that the thermal spray conditions were changed as shown in Table 5.

TABLE 5

| | Thermal spray core line | | | Average amount of |
|---|---|---|---|---|
| Thermal spray | First | Second | Third | deposition |
| conditions | layer | layer | layer | (μm) |
| C1 | Al | Zn | — | 8 |
| C2 | Zn | Al | — | 10 |
| C3 | Al | Zn | Al | 13 |
| C4 | Al | Zn—5% Al | — | 15 |

### Comparative Examples 1 to 5

Chemical conversion-treated steel pipes C1 to C5 were produced in the same manner as in the case of chemical conversion-treated steel pipe 1 except that chemical conversion treatment solutions 17 to 21 were used, respectively, in place of chemical conversion treatment solution 1 and the thickness of the chemical conversion treatment coating film was changed to 3 μm.

### Examples 33 to 37

Chemical conversion-treated steel pipe 33 was produced in the same manner as in the case of chemical conversion-treated steel pipe 2 except that plated steel sheet B was used in place of plated steel sheet A. Chemical conversion-treated steel pipes 34 to 37 were produced in the same manner as in the case of chemical conversion-treated steel pipe 33 except that the type and film thickness of a chemical conversion treatment solution were changed as shown in Table 7.

### Examples 38 to 42

Chemical conversion-treated steel pipe 38 was produced in the same manner as in the case of chemical conversion-treated steel pipe 2 except that plated steel sheet C was used in place of plated steel sheet A. Chemical conversion-treated steel pipes 39 to 42 were produced in the same manner as in the case of chemical conversion-treated steel pipe 38 except that the type and film thickness of a chemical conversion treatment solution were changed as shown in Table 7.

### Examples 43 to 47

Chemical conversion-treated steel pipe 43 was produced in the same manner as in the case of chemical conversion-treated steel pipe 2 except that plated steel sheet D was used in place of plated steel sheet A. Chemical conversion-treated steel pipes 44 to 47 were produced in the same manner as in the case of chemical conversion-treated steel pipe 43 except that the type and film thickness of a chemical conversion treatment solution were changed as shown in Table 7.

### Examples 48 to 52

Chemical conversion-treated steel pipe 48 was produced in the same manner as in the case of chemical conversion-treated steel pipe 2 except that plated steel sheet E was used in place of plated steel sheet A. Chemical conversion-treated steel pipes 49 to 52 were produced in the same manner as in the case of chemical conversion-treated steel pipe 48 except that the type and film thickness of a chemical conversion treatment solution were changed as shown in Table 7.

### Comparative Examples 6 to 19

Chemical conversion-treated steel pipes C6 to C19 were produced in the same manner as in the case of chemical conversion-treated steel pipe 1 except that the type of a plated steel sheet and the type and film thickness of a chemical conversion treatment solution were changed as shown in Table 7.

For each of chemical conversion-treated steel pipes 1 to 52 and C1 to C19, classification, chemical conversion treatment solution No., the type of a plated steel sheet, pretreatment solution No., thermal spray conditions, chemical conversion treatment solution No. drying temperature, and the thickness of a chemical conversion treatment coating film (film thickness) are shown in Tables 6 and 7.

TABLE 6

| | | | | | Chemical | | |
|---|---|---|---|---|---|---|---|
| | Chemical | Plated | | Thermal | conversion | Drying | Film |
| | conversion-treated | steel | Pretreatment | spray | treatment | temperature | thickness |
| Classification | steel pipe No. | sheet | solution No. | conditions | solution No. | (° C.) | (μm) |
| Example 1 | 1 | A | — | C2 | 1 | 140 | 2.0 |
| Example 2 | 2 | A | — | C2 | 2 | 140 | 2.0 |
| Example 3 | 3 | A | — | C2 | 2 | 250 | 10.0 |
| Example 4 | 4 | A | — | C2 | 3 | 140 | 2.0 |
| Example 5 | 5 | A | — | C2 | 3 | 140 | 0.5 |
| Example 6 | 6 | A | — | C2 | 4 | 140 | 2.0 |
| Example 7 | 7 | A | — | C2 | 5 | 140 | 3.0 |
| Example 8 | 8 | A | — | C2 | 5 | 140 | 1.0 |
| Example 9 | 9 | A | — | C2 | 6 | 50 | 2.0 |
| Example 10 | 10 | A | — | C2 | 7 | 140 | 2.0 |
| Example 11 | 11 | A | — | C2 | 7 | 140 | 5.0 |
| Example 12 | 12 | A | — | C2 | 8 | 140 | 2.0 |
| Example 13 | 13 | A | — | C2 | 9 | 140 | 2.0 |
| Example 14 | 14 | A | — | C2 | 10 | 140 | 2.0 |
| Example 15 | 15 | A | — | C2 | 11 | 210 | 2.0 |
| Example 16 | 16 | A | — | C2 | 12 | 80 | 2.0 |
| Example 17 | 17 | A | — | C2 | 13 | 140 | 3.0 |
| Example 18 | 18 | A | — | C2 | 14 | 140 | 2.0 |
| Example 19 | 19 | A | — | C2 | 15 | 140 | 3.0 |
| Example 20 | 20 | A | — | C2 | 16 | 140 | 1.0 |
| Example 21 | 21 | A | B1 | C2 | 16 | 140 | 1.0 |
| Example 22 | 22 | A | B2 | C2 | 16 | 140 | 1.0 |
| Example 23 | 23 | A | B3 | C2 | 16 | 140 | 1.0 |
| Example 24 | 24 | A | B4 | C2 | 16 | 140 | 1.0 |
| Example 25 | 25 | A | B1 | C2 | 3 | 140 | 0.5 |
| Example 26 | 26 | A | B2 | C2 | 3 | 140 | 0.5 |
| Example 27 | 27 | A | B3 | C2 | 3 | 140 | 0.5 |
| Example 28 | 28 | A | B4 | C2 | 3 | 140 | 0.5 |
| Example 29 | 29 | A | — | — | 2 | 140 | 2.0 |
| Example 30 | 30 | A | — | C1 | 2 | 140 | 2.0 |
| Example 31 | 31 | A | — | C3 | 2 | 140 | 2.0 |
| Example 32 | 32 | A | — | C4 | 2 | 140 | 2.0 |
| Comparative | C1 | A | — | C2 | 17 | 140 | 3.0 |
| Example 1 | | | | | | | |
| Comparative | C2 | A | — | C2 | 18 | 140 | 3.0 |
| Example 2 | | | | | | | |
| Comparative | C3 | A | — | C2 | 19 | 140 | 3.0 |
| Example 3 | | | | | | | |
| Comparative | C4 | A | — | C2 | 20 | 140 | 3.0 |
| Example 4 | | | | | | | |
| Comparative | C5 | A | — | C2 | 21 | 140 | 3.0 |
| Example 5 | | | | | | | |

TABLE 7

| | | | | | Chemical | | |
|---|---|---|---|---|---|---|---|
| | Chemical | Plated | | Thermal | conversion | Drying | Film |
| | conversion-treated | steel | Pretreatment | spray | treatment | temperature | thickness |
| Classification | steel pipe No. | sheet | solution No. | conditions | solution No. | (° C.) | (μm) |
| Example 33 | 33 | B | — | C2 | 2 | 140 | 2.0 |
| Example 34 | 34 | B | — | C2 | 4 | 140 | 2.0 |
| Example 35 | 35 | B | — | C2 | 7 | 140 | 2.0 |
| Example 36 | 36 | B | — | C2 | 14 | 140 | 2.0 |
| Example 37 | 37 | B | — | C2 | 15 | 140 | 3.0 |
| Example 38 | 38 | C | — | C2 | 2 | 140 | 2.0 |
| Example 39 | 39 | C | — | C2 | 4 | 140 | 2.0 |
| Example 40 | 40 | C | — | C2 | 7 | 140 | 2.0 |
| Example 41 | 41 | C | — | C2 | 14 | 140 | 2.0 |
| Example 42 | 42 | C | — | C2 | 15 | 140 | 3.0 |
| Example 43 | 43 | D | — | C2 | 2 | 140 | 2.0 |
| Example 44 | 44 | D | — | C2 | 4 | 140 | 2.0 |
| Example 45 | 45 | D | — | C2 | 7 | 140 | 2.0 |
| Example 46 | 46 | D | — | C2 | 14 | 140 | 2.0 |
| Example 47 | 47 | D | — | C2 | 15 | 140 | 3.0 |
| Example 48 | 48 | E | — | C2 | 2 | 140 | 2.0 |
| Example 49 | 49 | E | — | C2 | 4 | 140 | 2.0 |
| Example 50 | 50 | E | — | C2 | 7 | 140 | 2.0 |
| Example 51 | 51 | E | — | C2 | 14 | 140 | 2.0 |
| Example 52 | 52 | E | — | C2 | 15 | 140 | 3.0 |
| Comparative | C6 | B | — | C2 | 18 | 140 | 3.0 |
| Example 6 | | | | | | | |
| Comparative | C7 | B | — | C2 | 20 | 140 | 3.0 |
| Example 7 | | | | | | | |
| Comparative | C8 | C | — | C2 | 18 | 140 | 3.0 |
| Example 8 | | | | | | | |
| Comparative | C9 | C | — | C2 | 20 | 140 | 3.0 |
| Example 9 | | | | | | | |
| Comparative | C10 | D | — | C2 | 18 | 140 | 3.0 |
| Example 10 | | | | | | | |
| Comparative | C11 | D | — | C2 | 20 | 140 | 3.0 |
| Example 11 | | | | | | | |
| Comparative | C12 | E | — | C2 | 18 | 140 | 3.0 |
| Example 12 | | | | | | | |
| Comparative | C13 | E | — | C2 | 20 | 140 | 3.0 |
| Example 13 | | | | | | | |
| Comparative | C14 | F | — | C2 | 18 | 140 | 3.0 |
| Example 14 | | | | | | | |
| Comparative | C15 | F | — | C2 | 20 | 140 | 3.0 |
| Example 15 | | | | | | | |
| Comparative | C16 | G | — | C2 | 18 | 140 | 3.0 |
| Example 16 | | | | | | | |
| Comparative | C17 | G | — | C2 | 20 | 140 | 3.0 |
| Example 17 | | | | | | | |
| Comparative | C18 | F | — | C2 | 2 | 140 | 2.0 |
| Example 18 | | | | | | | |
| Comparative | C19 | G | — | C2 | 2 | 140 | 2.0 |
| Example 19 | | | | | | | |

### [Evaluation]

### (1) Gloss

For each of chemical conversion-treated steel pipes 1 to 52 and C1 to C19, the specular glossiness at 60° (G₆₀) of the surface on the chemical conversion treatment coating film side was measured with the gloss meter GMX-203 manufactured by MURAKAMI COLOR RESEARCH LABORATORY CO., Ltd. in accordance with “Specular glossiness-Methods of measurement” defined in JIS Z8741, and evaluation was performed by using the following criteria. “A” and “B” were regarded as a pass, and “C” and “D” were regarded as a fail.

A: the specular glossiness at 60° was 60 or lower.
B: the specular glossiness at 60° was higher than 60 and 150 or lower.
C: the specular glossiness at 60° was higher than 150 and 250 or lower.
D: the specular glossiness at 60° was higher than 250.

(2) Adhesion

A test piece including a thermal spray-repaired layer was cut out of each of chemical conversion-treated steel pipes 1 to 52 and C1 to C19, and the test piece was bent to the chemical conversion treatment coating film side by a 4 t bend. The bent portion of the chemical conversion treatment coating film was subjected to a cellophane tape peeling test to determine the proportion of the peeled area of the chemical conversion treatment coating film per unit area in the bent portion (peeled area fraction of the coating film, PA), and evaluation was performed by using the following criteria. “A” and “B” were regarded as a pass, and “C” and “D” were regarded as a fail.

A: the peeled area fraction of the coating film was 5% or less.
B: the peeled area fraction of the coating film was more than 5% and 10% or less.
C: the peeled area fraction of the coating film was more than 10% and 50% or less.
D: the peeled area fraction of the coating film was more than 50%.

(3) Corrosion Resistance

A test piece including a thermal spray-repaired layer was cut out of each of chemical conversion-treated steel pipes 1 to 52 and C1 to C19, and the surface of the test piece on the chemical conversion treatment coating film side was sprayed with a 5% NaCl aqueous solution at 35° C. in accordance with “Methods of salt spray testing” defined in JIS Z2371 to determine the area fraction of white rust generated on the surface (area fraction of white rust generation, WR) after spraying with the aqueous solution for 24 hours and after spraying with the aqueous solution for 72 hours, and evaluation was performed by using the following criteria. If the grade is “A” or “B”, there is no problem in practical use.

A: the WR was 5% or less.
B: the WR was more than 5% and 10% or less.
C: the WR was more than 10% and 40% or less.
D: the WR was more than 40%.

(4) Perspiration/Fingerprint Resistance

A test piece including a thermal spray-repaired layer was cut out of each of chemical conversion-treated steel pipes 1 to 52 and C1 to C19, and 100 pt of an artificial perspiration solution (alkaline) was dropped on the surface of the test piece on the chemical conversion treatment coating film side, and the portion was pressed with a rubber plug. Thereafter, the test piece was left to stand in a thermo-hygrostatic chamber having an inner environment of 70° C. and 95% RH for 240 hours. For the resultant test piece, the brightness difference (ΔL) between the pressed portion and the other was measured, and evaluation was performed by using the following criteria. If the grade is “A” or “B”, there is no problem in practical use.

A: the ΔL was 1 or lower.
B: the ΔL was higher than 1 and 2 or lower.
C: the ΔL was higher than 2 and 5 or lower.
D: the ΔL was higher than 5.

(5) Weatherability

A test piece including a thermal spray-repaired layer was cut out of each of chemical conversion-treated steel pipes 1 to 52 and C1 to C19, and the surface of the test piece on the chemical conversion treatment coating film side was subjected to an accelerated weathering test (xenon lamp method) in which a cycle (2 hours) consisting of water spray for 18 minutes during 120 minutes of irradiation with light from a xenon-arc lamp in accordance with a xenon lamp method defined in JIS K5600-7-7: 2008 was repeated 50 times. And then, the weatherability was evaluated in accordance with the thickness ratio (TR) of the chemical conversion treatment coating film of the test piece between before and after the test by using the following criteria. The thickness ratio can be determined by using the following equation. T₀ denotes the thickness before the test and T₁ denotes the thickness after the test. If the grade is “A” or “B”, there is no problem in practical use.

TR(%)=(T₁/T₀)×100

A: the TR was 95% or higher.
B: the TR was 80% or higher and lower than 95%.
C: the TR was 60% or higher and lower than 80%.
D: the TR was 30% or higher and lower than 60%.
E: the TR was lower than 30%.

For each of chemical conversion-treated steel pipes 1 to 52 and C1 to C19, classification, chemical conversion-treated steel pipe No., and the evaluation results are shown in Tables 8 and 9.

TABLE 8

| | | Evaluation | | | | | | | | | |
|---|---|---|---|---|---|---|---|---|---|---|---|
| | | | | | | Corrosion | | Perspiration/fingerprint | | | |
| | Chemical | | | Adhesion | | resistance | | resistance | | Weatherability | |
| | conversion-treated | Gloss | | PA | | WR | | ΔL* | | TR | |
| Classification | steel pipe No. | G₆₀ | Grade | (%) | Grade | (%) | Grade | (—) | Grade | (%) | Grade |
| Example 1 | 1 | 71 | B | 7 | B | 7 | B | 1.41 | B | 93 | B |
| Example 2 | 2 | 44 | A | 2 | A | 0 | A | 0.83 | A | 95 | A |
| Example 3 | 3 | 26 | A | 1 | A | 0 | A | 0.21 | A | 97 | A |
| Example 4 | 4 | 37 | A | 4 | A | 6 | B | 0.40 | A | 96 | A |
| Example 5 | 5 | 121 | B | 6 | B | 7 | B | 1.80 | B | 84 | B |
| Example 6 | 6 | 51 | A | 0 | A | 8 | B | 1.20 | B | 93 | B |
| Example 7 | 7 | 54 | A | 0 | A | 6 | B | 0.60 | A | 87 | B |
| Example 8 | 8 | 97 | B | 0 | A | 6 | B | 1.55 | B | 83 | B |
| Example 9 | 9 | 65 | B | 0 | A | 0 | A | 1.43 | B | 83 | B |
| Example 10 | 10 | 64 | B | 3 | A | 0 | A | 1.20 | B | 96 | A |
| Example 11 | 11 | 32 | A | 2 | A | 0 | A | 0.40 | A | 98 | A |
| Example 12 | 12 | 63 | B | 2 | A | 0 | A | 1.28 | B | 94 | B |
| Example 13 | 13 | 71 | B | 0 | A | 0 | A | 1.34 | B | 87 | B |
| Example 14 | 14 | 92 | B | 0 | A | 7 | B | 1.52 | B | 88 | B |
| Example 15 | 15 | 30 | A | 2 | A | 6 | B | 1.20 | B | 98 | A |
| Example 16 | 16 | 40 | A | 0 | A | 0 | A | 0.43 | A | 84 | B |
| Example 17 | 17 | 48 | A | 0 | A | 6 | B | 0.62 | A | 86 | B |
| Example 18 | 18 | 62 | B | 0 | A | 0 | A | 1.31 | B | 84 | B |
| Example 19 | 19 | 24 | A | 0 | A | 7 | B | 1.10 | B | 88 | B |
| Example 20 | 20 | 72 | B | 0 | A | 6 | B | 1.54 | B | 87 | B |
| Example 21 | 21 | 65 | B | 0 | A | 0 | A | 0.93 | A | 85 | B |
| Example 22 | 22 | 63 | B | 0 | A | 0 | A | 0.94 | A | 86 | B |
| Example 23 | 23 | 62 | B | 0 | A | 0 | A | 0.90 | A | 83 | B |
| Example 24 | 24 | 65 | B | 0 | A | 0 | A | 0.92 | A | 84 | B |
| Example 25 | 25 | 110 | B | 0 | A | 0 | A | 0.85 | A | 85 | B |
| Example 26 | 26 | 105 | B | 0 | A | 0 | A | 0.89 | A | 87 | B |
| Example 27 | 27 | 98 | B | 0 | A | 0 | A | 0.92 | A | 88 | B |
| Example 28 | 28 | 120 | B | 0 | A | 0 | A | 0.94 | A | 87 | B |
| Example 29 | 29 | 43 | A | 2 | A | 0 | A | 0.81 | A | 93 | B |
| Example 30 | 30 | 46 | A | 2 | A | 0 | A | 0.82 | A | 92 | B |
| Example 31 | 31 | 44 | A | 2 | A | 0 | A | 0.80 | A | 94 | B |
| Example 32 | 32 | 47 | A | 2 | A | 0 | A | 0.82 | A | 94 | B |
| Comparative | C1 | 63 | B | 70 | D | 6 | B | 2.32 | C | 96 | A |
| Example 1 | | | | | | | | | | | |
| Comparative | C2 | 62 | B | 0 | A | 8 | B | 1.24 | B | 24 | E |
| Example 2 | | | | | | | | | | | |
| Comparative | C3 | 62 | B | 0 | A | 9 | B | 1.32 | B | 21 | E |
| Example 3 | | | | | | | | | | | |
| Comparative | C4 | 260 | D | 0 | A | 6 | B | 6.30 | D | 84 | B |
| Example 4 | | | | | | | | | | | |
| Comparative | C5 | 27 | A | 65 | D | 30 | C | 0.30 | A | 80 | B |
| Example 5 | | | | | | | | | | | |

TABLE 9

| | | Evaluation | | | | | | | | | |
|---|---|---|---|---|---|---|---|---|---|---|---|
| | | | | | | Corrosion | | Perspiration/fingerprint | | | |
| | Chemical | | | Adhesion | | resistance | | resistance | | Weatherability | |
| | conversion-treated | Gloss | | PA | | WR | | ΔL* | | TR | |
| Classification | steel pipe No. | G₆₀ | Grade | (%) | Grade | (%) | Grade | (—) | Grade | (%) | Grade |
| Example 33 | 33 | 49 | A | 2 | A | 0 | A | 0.94 | A | 93 | B |
| Example 34 | 34 | 54 | A | 0 | A | 8 | B | 1.32 | B | 92 | B |
| Example 35 | 35 | 63 | B | 3 | A | 0 | A | 1.20 | B | 92 | B |
| Example 36 | 36 | 65 | B | 0 | A | 0 | A | 1.32 | B | 81 | B |
| Example 37 | 37 | 27 | A | 0 | A | 6 | B | 1.10 | B | 84 | B |
| Example 38 | 38 | 46 | A | 2 | A | 0 | A | 0.84 | A | 93 | B |
| Example 39 | 39 | 52 | A | 0 | A | 8 | B | 1.23 | B | 92 | B |
| Example 40 | 40 | 64 | B | 3 | A | 0 | A | 1.20 | B | 93 | B |
| Example 41 | 41 | 66 | B | 0 | A | 0 | A | 1.35 | B | 81 | B |
| Example 42 | 42 | 24 | A | 0 | A | 6 | B | 1.19 | B | 84 | B |
| Example 43 | 43 | 44 | A | 2 | A | 0 | A | 0.90 | A | 93 | B |
| Example 44 | 44 | 50 | A | 0 | A | 8 | B | 1.20 | B | 92 | B |
| Example 45 | 45 | 62 | B | 3 | A | 0 | A | 1.21 | B | 93 | B |
| Example 46 | 46 | 65 | B | 0 | A | 0 | A | 1.34 | B | 81 | B |
| Example 47 | 47 | 22 | A | 0 | A | 6 | B | 1.14 | B | 84 | B |
| Example 48 | 48 | 42 | A | 2 | A | 0 | A | 0.90 | A | 94 | B |
| Example 49 | 49 | 44 | A | 0 | A | 8 | B | 1.20 | B | 92 | B |
| Example 50 | 50 | 55 | A | 3 | A | 0 | A | 1.23 | B | 92 | B |
| Example 51 | 51 | 51 | A | 0 | A | 0 | A | 1.31 | B | 80 | B |
| Example 52 | 52 | 24 | A | 0 | A | 6 | B | 1.21 | B | 87 | B |
| Comparative | C6 | 64 | B | 0 | A | 8 | B | 1.30 | B | 22 | E |
| Example 6 | | | | | | | | | | | |
| Comparative | C7 | 261 | D | 0 | A | 7 | B | 7.52 | D | 82 | B |
| Example 7 | | | | | | | | | | | |
| Comparative | C8 | 66 | B | 0 | A | 8 | B | 1.30 | B | 21 | E |
| Example 8 | | | | | | | | | | | |
| Comparative | C9 | 275 | D | 0 | A | 8 | B | 7.20 | D | 83 | B |
| Example 9 | | | | | | | | | | | |
| Comparative | C10 | 65 | B | 0 | A | 9 | B | 1.20 | B | 25 | E |
| Example 10 | | | | | | | | | | | |
| Comparative | C11 | 274 | D | 0 | A | 8 | B | 7.10 | D | 82 | B |
| Example 11 | | | | | | | | | | | |
| Comparative | C12 | 48 | A | 0 | A | 7 | B | 1.20 | B | 25 | E |
| Example 12 | | | | | | | | | | | |
| Comparative | C13 | 53 | A | 0 | A | 7 | B | 6.20 | D | 85 | B |
| Example 13 | | | | | | | | | | | |
| Comparative | C14 | 74 | B | 0 | A | 60 | D | 1.12 | B | 24 | E |
| Example 14 | | | | | | | | | | | |
| Comparative | C15 | 289 | D | 0 | A | 50 | D | 4.30 | C | 85 | B |
| Example 15 | | | | | | | | | | | |
| Comparative | C16 | 48 | A | 0 | A | 30 | C | 1.12 | B | 31 | D |
| Example 16 | | | | | | | | | | | |
| Comparative | C17 | 52 | A | 0 | A | 20 | C | 3.30 | C | 88 | B |
| Example 17 | | | | | | | | | | | |
| Comparative | C18 | 56 | A | 2 | A | 50 | D | 0.96 | A | 92 | B |
| Example 18 | | | | | | | | | | | |
| Comparative | C19 | 44 | A | 2 | A | 20 | C | 0.82 | A | 93 | B |
| Example 19 | | | | | | | | | | | |

As is clear from Tables 8 and 9, chemical conversion-treated steel pipes 1 to 52 each of which included a chemical conversion treatment coating film produced by using one of chemical conversion treatment solutions 1 to 16 showed good results in the gloss of the surface of a chemical conversion-treated steel pipe on the chemical conversion treatment coating film side, and the adhesion, corrosion resistance, perspiration/fingerprint resistance, and weatherability of a chemical conversion treatment coating film.

In contrast, chemical conversion-treated steel pipe C1 was insufficient in perspiration/fingerprint resistance. This is presumably because the chemical conversion treatment coating film did not contain the base resin, and thus the chemical conversion treatment coating film had an insufficient barrier function to the artificial perspiration solution.

Chemical conversion-treated steel pipes C2, C3, C6, C8, C10, C12, C14, and C16 were insufficient in weatherability. This is presumably because the chemical conversion treatment coating film did not contain the fluororesin.

Chemical conversion-treated steel pipes C4, C7, C9, C11, C13, C15, and C17 were insufficient in perspiration/fingerprint resistance. This is presumably because, due to the insufficient content of the metal flake, a sufficiently homogenous distribution of the metal flakes was not achieved along the peripheral surface of the chemical conversion-treated steel pipe to cause the discoloration of the plating layer. In particular, chemical conversion-treated steel pipes C4, C7, C9, C11, and C15 were insufficient also in terms of an effect to suppress gloss. Chemical conversion-treated steel pipe C13 had a sufficiently low gloss, and this is because plated steel sheet E was a plated steel sheet having a sufficiently low surface gloss. In addition, chemical conversion-treated steel pipe C17 had a sufficiently low gloss, and this is also because plated steel sheet G was a plated steel sheet having a sufficiently low surface gloss.

Chemical conversion-treated steel pipes C1 and C5 were insufficient in adhesion. For chemical conversion-treated steel pipe C1, this is presumably because the base resin was not contained therein. For chemical conversion-treated steel pipe C5, this is presumably because the content of the metal flake was too high and the adhesive force due to the resin component (base resin) of the chemical conversion treatment coating film was insufficient.

Chemical conversion-treated steel pipes C5 and C14 to C19 were insufficient in corrosion resistance. For chemical conversion-treated steel pipe C5, this is presumably because the content of the metal flake was too high. For chemical conversion-treated steel pipes C14 to C19, this is presumably because plated steel sheets F and G were both a plated steel sheet having a low corrosion resistance and thus the corrosion resistance was not enhanced sufficiently even after chemical conversion treatment. Further, chemical conversion-treated steel pipes C14 and C16 were insufficient also in weatherability. This is presumably because the chemical conversion treatment coating film did not contain the fluororesin. Chemical conversion-treated steel pipes C15 and C17 were insufficient in perspiration/fingerprint resistance. This is presumably because the content of the metal flake was insufficient and thus a sufficiently homogenous distribution of the metal flakes was not achieved along the peripheral surface of the chemical conversion-treated steel pipe to cause the discoloration of the plating layer. In particular, chemical conversion-treated steel pipe C15 was insufficient also in terms of an effect to suppress gloss because of the insufficient content of the metal flake.

From the above results, it was found that a chemical conversion-treated steel pipe including: a plated steel pipe produced by welding a plated steel sheet; and a chemical conversion treatment coating film disposed on the surface of the plated steel pipe, in which the plated steel sheet includes a steel sheet and a zinc alloy disposed on the surface of the steel sheet and containing 0.05 to 60 mass % of aluminum and 0.1 to 10.0 mass % of magnesium, the chemical conversion treatment coating film contains a fluororesin, a base resin, a metal flake, and a chemical conversion treatment component, the base resin is one or more selected from the group consisting of a polyurethane, a polyester, an acrylic resin, an epoxy resin, and a polyolefin, the content of the fluororesin relative to the total amount of the fluororesin and the base resin is 3.0 mass % or more in terms of fluorine atoms, the content of the base resin relative to 100 parts by mass of the fluororesin in the chemical conversion treatment coating film is 10 parts by mass or more, and the content of the metal flake in the chemical conversion treatment coating film is more than 20 mass % and 60 mass % or less, has the adhesion of the chemical conversion treatment coating film and weatherability and exhibits suppressed gloss and suppressed discoloration over time.

The present application claims priority based on Japanese Patent Application No. 2014-215170 filed on Oct. 22, 2014. The contents disclosed in the specification and drawings are incorporated herein by reference in their entirety.

### INDUSTRIAL APPLICABILITY

The chemical conversion-treated steel pipe is excellent in the adhesion of the chemical conversion treatment coating film and weatherability with gloss and discoloration over time suppressed, and thus is useful for a steel pipe for a building frame of an agricultural greenhouse, for example, and in addition can be suitably used for other applications, for example, exterior building materials such as poles and beams for a building, members for conveyance, members for railroad vehicles, members for overhead lines, members for electric facilities, members for safe environment, structural members, mounts for photovoltaic power generation, and outdoor units of an air conditioner.

### REFERENCE SIGNS LIST

100 CHEMICAL CONVERSION-TREATED STEEL PIPE
110 STEEL SHEET
120 PLATING LAYER
130 PRETREATMENT COATING FILM
140 WELDED PORTION
150 BEAD-CUT PORTION
160 THERMAL SPRAY-REPAIRED LAYER
170 CHEMICAL CONVERSION TREATMENT COATING FILM
171 METAL FLAKE
172 WAX
173 VALVE METAL COMPOUND
174 SILANE COUPLING AGENT

1. A chemical conversion-treated steel pipe comprising: a plated steel pipe produced by welding a plated steel sheet; and a chemical conversion treatment coating film disposed on a surface of the plated steel pipe, wherein:
the plated steel sheet includes a steel sheet and a zinc alloy disposed on a surface of the steel sheet and containing 0.05 to 60 mass % of aluminum and 0.1 to 10.0 mass % of magnesium,
the chemical conversion treatment coating film contains a fluororesin, a base resin, a metal flake, and a chemical conversion treatment component,
the base resin is one or more selected from the group consisting of a polyurethane, a polyester, an acrylic resin, an epoxy resin, and a polyolefin,
a content of the fluororesin relative to a total amount of the fluororesin and the base resin is 3.0 mass % or more in terms of fluorine atoms,
a content of the base resin relative to 100 parts by mass of the fluororesin in the chemical conversion treatment coating film is 10 parts by mass or more, and
a content of the metal flake in the chemical conversion treatment coating film is more than 20 mass % and 60 mass % or less.

2. The chemical conversion-treated steel pipe according to claim 1, wherein the metal flake is one or more selected from the group consisting of an aluminum flake, an aluminum alloy flake, and a stainless steel flake.

3. The chemical conversion-treated steel pipe according to claim 1, wherein the chemical conversion treatment coating film has a film thickness of 0.5 to 10 μm.

4. The chemical conversion-treated steel pipe according to claim 1, wherein the content of the base resin relative to 100 parts by mass of the fluororesin in the chemical conversion treatment coating film is 900 parts by mass or less.

5. The chemical conversion-treated steel pipe according to claim 1, wherein:
the chemical conversion treatment component includes a valve metal compound including one or more selected from the group consisting of Ti, Zr, Hf, V, Nb, Ta, Mo, and W, and
a content of the valve metal compound in the chemical conversion treatment coating film based on the chemical conversion treatment coating film is 0.005 to 5.0 mass % in terms of metal.

6. The chemical conversion-treated steel pipe according to claim 1, wherein the chemical conversion treatment coating film further contains one or both of a silane coupling agent and a phosphate salt.

7. The chemical conversion-treated steel pipe according to claim 1, wherein:
the plated steel sheet has been pretreated with a phosphate compound or a valve metal component, and
the valve metal component is one or more selected from the group consisting of Ti, Zr, Hf, V, Nb, Ta, Mo, and W.

8. The chemical conversion-treated steel pipe according to claim 1, wherein:
the plated steel pipe further includes a thermal spray-repaired layer covering a welded portion of the plated steel pipe, and
an Al concentration in a surface of the thermal spray-repaired layer is 0.05 atom % or more.

9. The chemical conversion-treated steel pipe according to claim 1, wherein the chemical conversion treatment coating film further contains a pigment.

10. The chemical conversion-treated steel pipe according to claim 1, wherein the chemical conversion treatment coating film further contains a wax.

11. The chemical conversion-treated steel pipe according to claim 1, being a steel pipe for a building frame of an agricultural greenhouse.
